(19) United States
(12) Patent Application Publication
(10) Pub. No.: US 2022/0194873 A1
(43) Pub. Date: Jun. 23, 2022

(54) CONCENTRATED COMPOSITION FOR PLANT NUTRITION

(71) Applicant: TOTAL GROW, LLC, SHERIDAN, WY (US)

(72) Inventor: Agustin Carlos CASALINS CUNADO, Buenos Aires (AR)

(21) Appl. No.: 17/669,148

(22) Filed: Feb. 10, 2022

Related U.S. Application Data
(63) Continuation-in-part of application No. 16/442,561, filed on Jun. 17, 2019, now Pat. No. 11,325,872.

(51) Int. Cl. C05G 3/00; A01C 21/00

(52) U.S. Cl. CPC C05G 3/00; A01G 22/15; A01C 21/007

(57) ABSTRACT

A concentrated composition for plant nutrition. The composition includes a polymeric stabilizing agent having a high number of polar hydrophilic groups, such as microfibrillated cellulose (MFC), comprising calcium ions, sulfate ions and salts of other elements for plant nutrition. The concentration of calcium ions and sulfate ions and other essential elements exceeds the concentration corresponding to the normal solubility of calcium sulfate and other insoluble salts in water. The proportion of the polymeric stabilizing agent having a high number of polar hydrophilic groups is within a range of 1% and 99% w/w of the suspension. The availability of the nutrient elements is assured within a pH range of 1 to 13.

### RELATED APPLICATION

This application claims the benefit of priority as a continuation-in-part of U.S. patent application Ser. No. 16/442,561 filed on Jun. 17, 2019, the contents of which are incorporated in this application by reference in their entirety.

### TECHNICAL FIELD

The present disclosure relates generally to nutrient compositions for plants. More specifically, it pertains to a concentrated aqueous composition that includes nutrients which are useful for plant growth using hydroponics, fertirrigation or direct soil or substrate fertilization.

### BACKGROUND OF THE DISCLOSURE

By way of background, described below are (A) an introduction to plant nutrition; (B) a description of hydroponics and fertirrigation; (C) information about soil or substrate fertilization; and (D) a summary of the environmental impact of fertilizers.

A. Introduction to Plant Nutrition

Out of all the known natural elements, only 60 elements have been found in various plants and only 16 elements are generally considered essential for plant growth. Although most plants require only 16 essential elements, some species may need others. The essential elements are divided into two categories: macroelements and microelements.

Macroelements include carbon (C), hydrogen (H), oxygen (O), nitrogen (N), phosphorus (P), potassium (K), calcium (Ca), sulfur (S) and magnesium (Mg). Carbon, hydrogen and oxygen are obtained from water and air. The other elements are obtained from nutrient solutions, fertilizers or the soil.

Microelements include iron (Fe), chlorine (Cl), manganese (Mn), boron (B), zinc (Zn), copper (Cu), molybdenum (Mo) and sodium (Na). They are absorbed in much smaller quantities by the plant as compared to macroelements.

There are a series of microelements which are recognized by some authors as beneficial for plants but not necessarily essential for plant growth. These include cobalt (Co), nickel (Ni), selenium (Se), silicon (Si), vanadium (V), titanium (Ti) and aluminum (Al).

The elements are not absorbed by plants in their elemental form, but rather as cations or anions. For example, calcium is generally supplied as a divalent cation by inorganic salts such as calcium nitrate, which also provides nitrogen in the form of nitrates. Nitrogen can be provided through any salt containing nitrates or through ammonium fertilizers. Nitrogen is often supplied in the form of urea, an organic compound which requires chemical processes (hydrolysis and nitrification) to occur in the soil before the plant can absorb its nitrogen.

Plants also require a form of sulfur to be utilized in the formation of amino acids which are involved in their process of growth. Sulfur is usually provided by inorganic sulfate, which can be easily utilized by plants. Inorganic salts such as potassium sulfate or magnesium sulfate provide sulfur.

Phosphorus is supplied through phosphates and polyphosphates: monopotassium phosphate, monoammonium phosphate and diammonium phosphate are most commonly used. The need for potassium is satisfied by potassium salts: potash, potassium nitrate, monopotassium phosphate, potassium chloride and potassium sulfate are most frequently used.

The elements must be present in certain soluble forms in water to be able to be absorbed by plants. When an element is present in its absorbable form, it is said to be available for plant absorption. If an element is not in this available form, for example, if it is present as a non-absorbable compound or an insoluble precipitate, it cannot be absorbed and is of no use to the plant. For example, urea must undergo two chemical processes to transform the organic nitrogen into nitrates which are available for absorption. Another example is solid calcium sulfate, which is very insoluble in water and so the calcium and sulfate ions it contains are unavailable for plant absorption.

In agriculture, crop yields and quality are greatly impacted by the availability of mineral nutrients in the soil, substrate or nutrient solution. Hydroponics or fertirrigation are two techniques which allow the farmer to feed precisely the correct amount of each nutrient to intensive crops at the correct time. However, these techniques require large investments in equipment, chemical skill in order to correctly formulate nutritional solutions and great knowledge in order to control and correct pH, electrical conductivity and nutritional balance in their systems. In extensive and intensive soil-based farming, delivering the necessary nutrients is far more complicated due to nutrient-nutrient interactions, nutrient-soil interactions and dependency on weather patterns and microbiological activity. Furthermore, due to these complications, estimation of nutrient requirements versus expected yields is imprecise and often limiting. Currently the fertilizer industry has not managed to assure efficient, full-cycle, pH-independent nutrient availability in a single fertilizer product—not for hydroponics, fertirrigation or direct soil or substrate fertilization.

B. Hydroponics and Fertirrigation

In intensive crops that require hydroponic nutrition or fertirrigation, plants are supplied with all the elements by nutrient solutions prepared by dissolving fertilizing salts in water. The formulations for fertilizers in hydroponics and fertirrigation vary according to the specific requirements of each crop, its stage of development and the surrounding climatic conditions. Concentrated nutrient solutions called “stock” solutions are used as fertilizers. Stock solutions are formulated by mixing inorganic salts in high concentrations and their purpose is to provide plants with all the mineral elements that they require throughout their lifecycle.

In hydroponics or fertirrigation, in order to provide the crops with all the needed elements, two different “stock” solutions, generally called “A” and “B,” containing high concentrations of all the necessary elements must be prepared. The solutions need to be prepared separately in order to avoid precipitation of insoluble salts due to the high concentration of incompatible ions. Most important, calcium sulfate, from calcium provided in stock A and sulfur in the form of inorganic sulfate provided in stock B, will precipitate if stock A and stock B are mixed without dilution. If these elements were to precipitate, they would no longer be available for absorption by plants.

It is important to clarify that both calcium and sulfur are essential elements for plants and must be added to nutrient solutions. Calcium is utilized for growth while sulfur is utilized to form amino acids. The latter is usually provided as inorganic sulfate because, in this form, it can be easily absorbed by the plants.

Calcium sulfate is poorly soluble in water (at a rate of 0.67 grams/liter at 77° F. and neutral pH). Therefore, nutrient solutions are formulated as stock A and B so as to add calcium and sulfate separately. It would not be commercially viable to formulate a diluted solution combining calcium and sulfate at such low levels of concentration in order to avoid the precipitation of calcium sulfate.

Another important feature of solutions stock A and stock B is that they must both have a controlled, slightly acidic pH. Each of the 13 essential mineral elements contained in these stock solutions present unique pH ranges where they are in an adequate form for absorption by plants. At a pH of 5 to 7, all the elements are sufficiently soluble and available for plant absorption. At lower and higher pH levels, however, the different elements are either protonated or form insoluble hydroxides which are no longer adequate species for plant absorption. The effect of pH not only affects calcium and sulfur but rather all of the elements. The pH level must be controlled so as to ensure the availability of all the nutrients in the solution.

Of all the elements contained in stock A and stock B solutions, microelements are some of the most complicated to maintain in a soluble, available form. To aid solubility and availability for plant absorption, chelates are widely used in hydroponics, fertirrigation and fertilization. Chelates are natural or synthetic substances which coordinate around microelement ions forming chemical complexes, limiting their interactions with the surrounding medium. Chelates are organic structures that are capable of “wrapping” ions, particularly of the microelements, thus making them stable in the solutions and preventing them from bonding with other ions and precipitating.

Chelates are particularly important for the provision of iron, because it is the microelement that can more easily form hydroxides and insoluble salts with other ions that are present in the nutrient solutions. It is worth mentioning that iron is essential for chlorophyll synthesis because it acts as a carrier of electrons during photosynthesis and cellular respiration, activating some enzymes as well. There cannot be a nutrient solution formulation without the incorporation of iron. To ensure the solubility of iron and avoid precipitation of iron hydroxides, it is often added in its chelated form. A preferred chelating agent is ethylenediaminetetraacetic acid (EDTA).

There have been attempts to solve the problem of calcium precipitation with sulfates by chelating calcium. Such attempts are not an industrially viable option, however, because calcium is a macroelement, meaning it is needed by the plant in large quantities. If it were to be chelated, not only would the volume of fertilizer increase several-fold but a very large amount of chelate would be incorporated into the nutrient solution or soil. Because chelates are not usually ion-specific, a large amount of calcium chelate in the solution or soil would likely have a negative effect on the availability of other metal cations. Furthermore, chelates are a relatively costly addition to nutrient solutions and a large requirement for chelates would not be financially viable.

Also, calcium chelate only remains stable in a pH that ranges from 6 to 14, while on the other hand iron chelate remains stable only under acidic conditions. Therefore, the pH range that would enable the incorporation of all the nutrients by using both chelates is very limited (6 to 7). This complicates the obtainment process of the solution and threatens the concentrations of salts that require higher levels of acidity.

The need to control pH at slightly acidic levels to ensure nutrient availability also limits the uses of nutrient solutions in industrial applications. Stock A and stock B solutions are used in hydroponics and fertirrigation, but cannot be used directly as fertilizers for soil because they are not capable of protecting the nutrients from external pH conditions. For example, if stock A and stock B solutions were diluted, mixed, and fed to plants growing in alkaline soil, the same insoluble salts mentioned previously would likely form upon interaction with soil particles which would reduce the availability of the elements fed to the plant. In fact, nutrient availability is an important issue in soil fertilization, because large quantities of nutrients are tied up by soil particles or form insoluble compounds due to inadequate soil pH.

C. Soil or Substrate Fertilization

There are many conditions that hinder the optimal mineral nutrition of a crop grown in soil or substrate. The optimal mineral nutrition is one that ensures that the plant can perform biological processes, including photosynthesis, continuously, without restrictions due to lack of mineral nutrients. Following is a list of conditions which affect nutrient availability in soil and substrates.

Absence of organic matter (OM): OM is the most widely used soil fertility indicator. It is a source of nutrients and ensures their availability due to its capacity to retain and exchange cations (cation exchange capacity), stabilize micronutrients and act as a buffer against sudden changes in soil pH. In the last few decades, the intensification of agriculture and the lack of crop rotation have produced a remarkable decrease in the levels of organic matter, to the detriment of the fertility of the world's productive soils. Because the replenishment of organic matter a costly process that requires long periods of time, the way to replenish soil fertility is through fertilizer products. The lower the amount of organic matter in soil, the more fertilizer product needs to be applied in order to achieve the expected yield. Furthermore, in low organic matter soils with consequent low ion exchange capacity, once fertilizers are added and solubilized in the soil solution, the soil has no capacity to conserve the solubilized, available nutrients until uptake by crop roots. Nutrients are therefore more easily lost due to immobilization or leaching, reducing fertilizer efficiency and leading to the need to add even more fertilizer to achieve equivalent yields.

Soil or substrate pH: Crop production in acid soils (pH below 6) prevents high yield potentials from being achieved because nutrient uptake is inhibited. There are many factors that acidify the soil: excess presence of certain nutrients such as calcium, magnesium and potassium; excess rainfall; decomposition of organic matter; and the use of fertilizers that contain or form ammonium. All these phenomena cause a release of protons to the soil. The most common solution to acidity is the application of calcareous amendments (such as carbonates, oxides, hydroxides, calcium and/or magnesium silicates). For example, to correct the pH of the upper 15-20 cm of soil from a value of 4.5 to 5.5, 1,500 to 2,000 kg of calcium carbonate per hectare are needed in sandy loam soils, while to raise it from 5.5 to 6.5, between 2,000 to 3,000 kg/ha are necessary. The elevation of pH in these same ranges in clay soils practically requires 4,000 to 6,000 kg/ha. The pH has a great effect on the assimilation of microelements in such a way that an increase in pH above 6.5 or 7 reduces the solubility and absorption of elements such as copper, iron, zinc and very markedly manganese.

Reactions in the soil: depending on the physical and chemical characteristics of the soil, nutrients react with different elements, decreasing their availability for plants. Chemical reactions include the binding of cations such as calcium and iron ions to clay particles, or the binding of phosphates to calcium carbonate or aluminum/iron oxide. The different reactions that occur result in the fixation of nutrients with edaphological elements of the soil.

Excess free ions: when a soil contains excess soluble salts, generally as a consequence of inadequate fertilization management, some negative effects are generated Among these effects are (i) increase of osmotic potential which impairs a plant's ability to absorb water; (ii) phytotoxicity of certain elements in excessive concentrations; and (iii) nutrient antagonism by which nutrients compete for uptake by plants and the excessive presence of one element may impede the absorption of another (for example, an excess of calcium may cause magnesium and boron deficiencies).

Chemical incompatibility between salts: some compounds used as fertilizers cannot be mixed at high concentrations either in a nutrient solution or in the soil solution because they react with each other forming insoluble salts, preventing the industry from formulating complete compositions with the optimal mineral nutrition according to the requirements of each crop species. Some examples of incompatibility of mineral salts are:

Calcium nitrate is incompatible with phosphates and sulphates, including potassium sulphate, ammonium phosphate, ammonium sulphate, iron sulphate, zinc sulphate, copper sulphate and manganese sulphate, magnesium sulphate, phosphoric acid and sulfuric acid.

Ammonium phosphate is incompatible with a range of metal cations, including iron sulphate, zinc sulphate, copper sulphate, manganese sulphate and magnesium sulphate.

Phosphoric acid is incompatible with iron chelate, zinc chelate, copper chelate and manganese chelate.

Nitric acid is incompatible with iron chelate, zinc chelate, copper chelate and manganese chelate.

Commercial solid fertilizer products containing multiple elements overcome chemical incompatibility during production by physically mixing individual dry solid substances, but present two problems for the farmer. First, solid mixtures are often heterogeneous, leading to nutrient deficiencies. Second, chemical incompatibility once the product comes into contact with the soil solution is not avoided by these solid mixtures.

Difficulty in supplying microelements: microelements are nutrients that, although required in minute quantities, are essential for crop development. Historically, agricultural producers have depended on naturally occurring trace quantities of microelements in the soil for their supply. However, the degradation of soils due to intensive harvesting and the lack of mineral replenishment, in particular of microelements, has generated the need to include them in fertilization practices. The interactions of microelements with each other and with other nutrients can lead to deficiencies if micronutrient concentrations are unbalanced, for example:

Iron reduces the assimilation of phosphorus, manganese, copper and zinc.

Zinc reduces the assimilation of phosphorus and iron, and affects the solubility of nitrogen.

Copper reduces the assimilation of nitrogen, phosphorus and zinc.

Particularly, phosphorus interacts strongly with microelements, so high levels of phosphate fertilization can cause reductions in the assimilation of iron, copper, and especially zinc. Chelated microelements are routinely used in the industry and they help to avoid the interaction of microelement ions with phosphates, therefore reducing their precipitation as insoluble salts. Their disadvantage is that they are very expensive and logistically inefficient because the chelate makes up most of the weight of the complex (70% to 90%). Micronutrients are often supplied as chelates via foliar application, a technique which bypasses the problems presented in the soil but is costly and inefficient.

Forms of nitrogen: nitrogen is the most important nutrient in terms of quantity absorbed by a plant, and it is absorbed mainly in the form of nitrates. However, nitrogen is not always supplied to the soil or substrate in this form. Ammonium ions in substances such as ammonium nitrate and organic compounds such as urea are often used, which require chemical processes to transform the nitrogen into its most available form. The need to transform nitrogen leads to delays in nutrient uptake. The fertilizer industry has had a hard time producing a cost-efficient, permanently available nitrogen supply to replace the use of urea and ammonium nitrate and so continuing use of these substances has led to excessive fertilization and higher operative costs.

Given all these factors, optimal mineral nutrition is difficult to achieve in soil or substrate, and consequently potential yields are not reached. The lack of availability of one or more elements inhibits growth until the deficiency is cured. This condition is known as Liebig's law of minimum, which states that the yield of a crop is determined by the nutrient element that is found in the least amount. An excess of any other nutrient cannot compensate for the deficiency of the limiting nutrient.

In ideal climatic or environmental conditions, the nutritional requirements for a certain expected yield of a crop can be calculated to a high degree of precision given known absorption requirements and nutrient partition coefficients, which indicate the percentage of nutrients absorbed whose destination is the fruit or grain of a crop. In general terms, approximately 95% of crop biomass is water and of the remaining 5%, approximately 95% is made up of carbon, oxygen and hydrogen, meaning that approximately 0.025% of the plant biomass is made up of essential and beneficial elements. When the elemental composition of a crop and its fruit is known, the nutritional requirements for specific yields can be calculated and fertilizers applied in consequence. Due to the limitations of the fertilizer industry described previously, farmers do not currently apply fertilizers according to these theoretical estimations, generating large inefficiencies and lower than potential yields.

D. Environmental Impact of Fertilizers

In addition, there are environmental harms associated with the use of many fertilizers. Nitrogen fertilizers are responsible for 17% of global ammonia emissions. Among nitrogen fertilizers, urea is the most widely used. Urea produces ammonia upon hydrolysis in the soil or substrate, which volatilizes very easily and acts as a precursor to nitrous oxide (N2O) and nitric oxide (NO), which weaken the ozone layer. Nitrous oxide (N2O) is a gas with a warming potential 298 times greater than carbon dioxide (CO2). Nitric oxide, in turn, contributes to acid rain. Of all the nitrogen supplied to the crop by urea, on average only 30% is assimilated by the plants while the rest is lost by volatilization or leaching. Leaching is the loss of water-soluble compounds due to rain and irrigation, which contributes to the contamination of rivers and groundwaters.

As an alternative to urea, ammonium nitrate can be used as a nitrogen source, as ammonia emissions are estimated to be 63% lower than those of urea. However, its explosivity is a great disadvantage and therefore its commercialization is highly restricted. In order to market it, it is sometimes mixed with around 20% calcium oxide, which reduces its explosive quality. However, this makes it an insoluble product, a less efficient source of nitrogen and a source of unavailable calcium which can accumulate in soils. Ammonium nitrate is also a more expensive fertilizer than urea when the percentage contribution of nitrogen is taken into account, even in its pure form.

Phosphorus use is another culprit of negative environmental impact. When phosphorus fertilizers are used incorrectly, due for example to underestimation of soil phosphorus content or overestimation of crop yields, excess phosphorus generates the eutrophication of rivers, lakes and streams as it runs off the surface due to rainfall and flows into them. Eutrophication is the progressive enrichment of the mineral content of bodies of water, which leads to ecological imbalances. The world's phosphorus reserves are limited and at the current rate of consumption, reserves are estimated to last between 30 and 80 years. A shortage of phosphate rock is likely to threaten the world's ability to produce food, as there is no substitute for this mineral. It is of great importance that the fertilizer industry take care in the use of phosphorus fertilizers, maximizing their efficiency and minimizing their negative environmental effects.

It would be desirable to have a single concentrated product comprising all the necessary and beneficial ingredients for plant growth, which assures the availability of elements such as calcium, sulfur and iron; avoids the use of chelates; does not require tight control of the pH to ensure plant nutrient availability; provides nutrient availability unaffected by the pH and chemical and physical conditions of the application environment; and has no or minimal adverse environmental impact. Such a concentrated product could be used interchangeably for hydroponics, fertirrigation and direct soil or substrate fertilization.

Surprisingly, the inventors have found that using a polymeric stabilizing agent having a high number of polar hydrophilic groups, such as microfibrillated cellulose (MFC), assures the availability of all essential elements in a pH range from 1 to 13. In a preferred embodiment, a composition with MFC is described that combines all the essential elements in a balanced and complete way according to the nutritional requirements of each crop, in a form that is 100% available regardless of the physical and chemical conditions of the soil (such as its composition, the degree of organic matter, pH, etc.) and with low environmental impact (no losses by volatilization, leaching or run-off, and high logistical efficiency). In addition, the present composition comprising MFC allows the incorporation of ammonium nitrate as a source of nitrogen rendering the mixture stable and non-explosive.

### SUMMARY OF THE DISCLOSURE

A main object of the disclosure is a nutrient composition that combines essential, and optionally beneficial, elements for plant nutrition in balanced proportions which reflect crop nutritional demands in a single stabilized composition comprising a polymeric stabilizing agent having a high number of polar hydrophilic groups, such as microfibrillated cellulose, and a concentration of calcium and sulfate and other essential elements in excess of that corresponding to the normal solubility of calcium sulfate and other insoluble salts in water, wherein the availability of all essential elements is assured in a pH range from 1 to 13.

More specifically, an object of the disclosure is a concentrated aqueous composition comprising a stabilizing polymeric agent having a high number of polar hydrophilic groups, such as microfibrillated cellulose, and elements for plant nutrition wherein the concentrated aqueous composition comprises microfibrillated linear polymers of D-glucose molecules (cellulose microfibers), calcium ions, sulfate ions and other essential elements for plant nutrition such as nitrogen, phosphorus, potassium, magnesium, iron, chlorine, manganese, boron, zinc, copper, molybdenum, and other beneficial elements for plant nutrition such as silicon, selenium, nickel and cobalt, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension and wherein the availability of all essential elements is assured in a pH range from 1 to 13.

In some embodiments of the disclosure, the composition is a nutrient solution that combines stock A (which provides calcium and other essential elements for plant nutrition) and stock B (which provides sulfates and other essential elements for plant nutrition) in a single stabilized suspension, comprising microfibrillated cellulose and a concentration of calcium and sulfate and other essential elements in excess of that corresponding to the normal solubility of calcium sulfate and other insoluble salts in water.

In a preferable embodiment of the disclosure, the elements for plant nutrition are present in the aqueous concentrated composition as salts of the elements, preferably inorganic salts of the elements.

In some embodiments of the disclosure, the nutrient composition comprises microfibrillated cellulose and soluble inorganic salts of essential elements for plant nutrition directly, without previously preparing stock A and stock B solutions, having a concentration of calcium and sulfate and other essential elements in excess of that corresponding to the normal solubility of calcium sulfate and other insoluble salts in water.

Another object of the disclosure is a process for the preparation of a concentrated aqueous composition comprising microfibrillated cellulose and salts for plant nutrition wherein the process comprises the step of mixing microfibrillated linear polymers of D-glucose molecules (cellulose microfibers) and salts of calcium ions or sulfate ions and salts of other elements for plant nutrition such as nitrogen, phosphorus, potassium, magnesium, iron, chlorine, manganese, boron, zinc, copper, molybdenum, and others, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension.

Another object of the disclosure is a process for plant nutrition using hydroponics, fertirrigation or direct soil fertilization techniques including the step of supplying a concentrated aqueous composition comprising microfibrillated cellulose and salts for plant nutrition wherein the concentrated aqueous suspension comprises microfibrillated linear polymers of D-glucose molecules (cellulose microfibers), calcium ions, sulfate ions and other substances for plant nutrition such as nitrogen, phosphorus, potassium, magnesium, iron, chlorine, manganese, boron, zinc, copper, molybdenum, and others, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension.

Another object of the disclosure is a solid or semi-solid fertilizer composition including microfibrillated cellulose and salts for plant nutrition wherein the solid or semi-solid fertilizer composition comprises microfibrillated linear polymers of D-glucose molecules (cellulose microfibers), calcium ions, sulfate ions and other elements for plant nutrition such as nitrogen, phosphorus, potassium, magnesium, iron, chlorine, manganese, boron, zinc, copper, molybdenum, and others, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension and wherein the availability of all essential elements is assured in a pH range from 1 to 13.

Another object of the disclosure is a process for preparing a solid or semi-solid fertilizer including the step of dehydrating a concentrated aqueous composition up to a moisture content of less than 20% wherein the concentrated aqueous composition comprising microfibrillated cellulose and salts for plant nutrition comprises microfibrillated linear polymers of D-glucose molecules (cellulose microfibers), calcium ions, sulfate ions and other elements for plant nutrition such as nitrogen, phosphorus, potassium, magnesium, iron, chlorine, manganese, boron, zinc, copper, molybdenum, and others, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension.

Another object of the disclosure is a method for plant nutrition including the step of applying a solid or semi-solid fertilizer according to the present disclosure comprising microfibrillated cellulose and salts for plant nutrition wherein the concentrated aqueous suspension comprises microfibrillated linear polymers of D-glucose molecules (cellulose microfibers), calcium ions, sulfate ions and other elements for plant nutrition such as nitrogen, phosphorus, potassium, magnesium, iron, chlorine, manganese, boron, zinc, copper, molybdenum, and others, wherein the concentration of calcium ions and sulfate ions and other essential elements exceeds the concentration corresponding to the normal solubility of calcium sulfate and other insoluble salts in water and wherein the proportion of microfibrillated cellulose (MFC) is within a range of 1% and 99% w/w of the suspension to a soil or substrate and wherein the availability of all essential elements is assured in a pH range from 1 to 13.

Another object of the disclosure is a substrate kit comprising: an inert substrate suitable for crop growth; a concentrated aqueous composition comprising microfibrillated cellulose and salts for plant nutrition, or a solid or semi-solid fertilizer composition comprising microfibrillated cellulose and salts for plant nutrition; and optionally a seed, bulb or seedling of a crop which requires the specific nutrients delivered in the concentrated aqueous suspension or solid or semi-solid fertilizer composition.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. Included in the drawing is the following FIGURE:

FIG. 1 is a graph of accumulated moles of leached potassium and dihydrogen phosphate ions in solution during leaching from a rockwool substrate with and without MFC retention.

### DETAILED DESCRIPTION OF SPECIFIC EMBODIMENTS

In this specification and in the claims that follow, reference will be made to a number of terms which shall be defined to have the following meanings ascribed to them. The term “substantially,” as used in this document, is a descriptive term that denotes approximation and means “considerable in extent” or “largely but not wholly that which is specified” and is intended to avoid a strict numerical boundary to the specified parameter. “Include,” “includes,” “including,” “have,” “has,” “having,” comprise,” “comprises,” “comprising,” or like terms mean encompassing but not limited to, that is, inclusive and not exclusive. The indefinite article “a” or “an” and its corresponding definite article “the” as used in this disclosure means at least one, or one or more, unless specified otherwise.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods and processes of the disclosure include those having any value or any combination of the values, specific values, more specific values, and preferred values described.

The formulations for fertilizers vary according to the specific requirements of each crop, its stage of development and the surrounding climatic conditions. The formulations may be based on the absorption or extraction requirements for each crop, may fulfill all of part of the nutrient requirements, and the soil or substrate nutrient provision may or may not be taken into account. For example, one formulation may be complete, containing the entire absorption or extraction requirements for the complete life cycle of a crop. In another example, a formulation may be partial, containing the absorption or extraction requirements for a portion of the life cycle of a crop, for example vegetative or reproductive stages. In yet another example, a formulation may be partial, containing a proportion of the total absorption or extraction requirements of a crop, taking into consideration a certain degree of uptake of nutrients from the soil or substrate. In yet another example, a formulation may be partial, containing all or a proportion of the total absorption or extraction requirements of a crop, with the exception of an excess or deficiency of one or more specific nutrients due to specific deficiencies or excesses in the soil or substrate.

Formulations of the present disclosure for different crops may contain the following % w/w of macronutrients, micronutrients and beneficial nutrients: 0.1 to 30% nitrogen, 0.1 to 20% phosphorus, 0.1 to 20% potassium, 0.1 to 20% sulfur, 0.1 to 20% calcium, 0.1 to 20% magnesium, 0.001 to 0.4% iron, 0.001 to 0.4% manganese, 0.001 to 2% zinc, 0.001 to 0.05% copper, 0.0001 to 0.003% molybdenum, 0.000001 to 0.01% cobalt, 0.001 to 0.2% boron, 0.000001 to 0.001% selenium, 0.000001 to 0.1% silicon and 0.000001 to 0.001% nickel.

In specific embodiments, formulations may contain the following % w/w of macronutrients, micronutrients and beneficial nutrients: 1 to 20% nitrogen, 1 to 10% phosphorus, 1 to 9% potassium, 1 to 10% sulfur, 0.5 to 10% calcium, 0.8 to 8% magnesium, 0.01 to 0.2% iron, 0.01 to 0.2% manganese, 0.01 to 0.3% zinc, 0.005 to 0.04% copper, 0.0002 to 0.0005% molybdenum, 0.00001 to 0.00008% cobalt, 0.002 to 0.1% boron, 0.00001 to 0.0008% selenium, 0.00001 to 0.05% silicon and 0.00001 to 0.0008% nickel.

In more specific embodiments, formulations may contain the following % w/w of macronutrients, micronutrients and beneficial nutrients: 3 to 11% nitrogen, 1.5 to 5% phosphorus, 3 to 7% potassium, 1.5 to 4% sulfur, 1 to 3% calcium, 1 to 2% magnesium, 0.04 to 0.08% iron, 0.02 to 0.05% manganese, 0.05 to 0.2% zinc, 0.01 to 0.02% copper, 0.0003 to 0.0004% molybdenum, 0.00003 to 0.00005% cobalt, 0.005 to 0.01% boron, 0.00003 to 0.0005% selenium, 0.00005 to 0.005% silicon and 0.00003 to 0.0005% nickel.

The salts and chelates which can be used to formulate a composition of the present disclosure are as follows:

Supplying nitrogen: ammonium nitrate, potassium nitrate, magnesium nitrate, ammonium sulfate, calcium nitrate, calcium ammonium nitrate.

Supplying phosphorus: monopotassium phosphate, dipotassium phosphate, phosphoric acid, monoammonium phosphate, diammonium phosphate.

Supplying potassium: potassium nitrate, potassium sulfate, monopotassium phosphate, dipotassium phosphate, potash, potassium chloride.

Supplying sulfur: magnesium sulfate, potassium sulfate, ammonium sulfate.

Supplying calcium: calcium nitrate, calcium ammonium nitrate, calcium chloride.

Supplying magnesium: magnesium sulfate, magnesium nitrate, magnesium EDTA.

Supplying iron: iron sulfate, iron nitrate, iron EDTA.

Supplying manganese: manganese sulfate, manganese nitrate, manganese EDTA.

Supplying boron: boric acid, sodium tetraborate.

Supplying zinc: zinc sulfate, zinc nitrate, zinc chloride, zinc EDTA:

Supplying copper: copper sulfate, copper nitrate, copper EDTA.

Supplying molybdenum: sodium molybdate, ammonium molybdate.

Supplying cobalt: cobalt sulfate, cobalt EDTA.

Supplying selenium: ammonium selenate.

Supplying silicon: potassium silicate, sodium silicate.

Supplying nickel: nickel sulfate, nickel EDTA.

The salts and chelates that are most commonly used for the formulation of stock A are as follows:

Calcium nitrate

Potassium nitrate (optional, since it is also present in stock B)

Ammonium nitrate

Potash

Potassium chloride

Calcium oxide

Calcium chloride

Iron ethylenediamine tetraacetic acid (Ferric EDTA)

Sodium molybdate (dihydrate)

Ammonium molybdate

Ethylenediamine tetraacetic manganese (Mn EDTA)

Manganese chloride

Ethylenediamine tetraacetic zinc (Zn EDTA)

Zinc chloride

Ethylenediamine tetraacetic magnesium (Mg EDTA)

Magnesium oxide

Ethylenediamine tetraacetic copper (Cu EDTA)

Ethylenediamine tetraacetic cobalt (Co EDTA)

Ethylenediamine tetraacetic nickel (Ni EDTA)

Boric acid

Sodium tetraborate

The most common salts to formulate stock B are:

Potassium sulfate

Magnesium sulfate

Ammonium sulfate

Ferrous sulfate

Copper sulfate

Magnesium sulfate

Zinc sulfate

Dipotassium phosphate

Monopotassium phosphate

Diammonium phosphate

Phosphoric anhydride

Potassium nitrate

As described above, stock A usually includes the nitrates (calcium, potassium and ammonium) and the EDTA-chelated microelements. However, another possible common formulation is to incorporate only the nitrates (calcium, potassium and ammonium) and the iron EDTA in stock A and to incorporate the microelements in the form of sulfates (magnesium, manganese, copper, zinc, etc.) in stock B, so that sulfates and calcium do not precipitate as calcium sulfate.

Surprisingly, the inventors found another alternative which involves the use of polymeric stabilizing agents having a high number of polar hydrophilic groups, such as microfibrillated cellulose (MFC) obtained from a fibrillation process of cellulose in a wet state.

Microfibrillated cellulose (MFC) is a substance composed of cellulose and water, with a cellulose concentration of less than 15%. It is characterized by being able to store large quantities of water in relation to its mass, obtaining “creamy” or “gel-type” suspensions with very low proportions of microfibrillated cellulose (as low as 2%). Its pH varies in a range from 4 to 8 and its density varies in a range between 1.2 and 1.6 kg/L.

Cellulose microfibrils are very small cellulose fibers obtained from the mechanical disintegration of plant fibers and by a sequence of specific chemical and mechanical treatments (the fibrillation process). A wide variety of plant fibers can be used to obtain cellulose microfibrils, the plant fibers including spruce, pine, bamboo, eucalyptus, citrus plants, sugar beet, flax and hemp, among others.

When the cellulose goes through a fibrillation process, the surface area becomes much larger in comparison with the original raw material, thus generating a significant increase in the quantity of hydroxyl groups (OH) available on the surface of the microfibrils. Because these hydroxyl groups have a natural negative charge, they will be able to capture ions with a positive charge, such as calcium ions. In this way, the calcium ions are prevented from bonding with the sulfates, avoiding altogether their precipitation as calcium sulfate.

The inventors shave discovered that the accessible hydroxyl and other polar functional groups such as carboxyl groups attached to the cellulosic chain in microfibrillated cellulose (MFC) have an affinity for nutrient ions and are able to prevent adverse reactions between the nutrient ions and/or the surrounding medium despite high concentrations and independently of the pH. More specifically, the high concentration of accessible hydroxyl and/or polar functional groups of the microfibrillated D-glucose polymer generates a polar environment which offers a degree of stabilization of the cations and anions present between the MFC fibers. Stabilizing electrostatic interactions are favored between the deprotonated hydroxyl and other polar groups and the nutrient ions. Stabilizing charge-dipole interactions are favored between the protonated hydroxyl and other polar groups and the nutrient ions. Stabilizing charge-dipole interactions between the water content between MFC fibers and nutrient ions are also favored. Such affinity between the microfibrillated cellulose fibers and nutrient ions favors the formation of layers of stabilized, soluble nutrient ions and water around the cellulose fibers, inhibiting the formation of insoluble compounds. The nutrient ions remain available for plant uptake as their affinity with the MFC is high enough to avoid reactions with each other or with the surrounding medium, but also weak enough to allow ion mobility and absorption by the plant.

The stabilization of nutrient ions offered by the microfibrillated cellulose can be compared to the action of chelates in traditional nutrient solution formulation. Just as chelates interact strongly with nutrient ions, reducing their chance of precipitation, so do the hydroxyl and other polar groups interact with the nutrient ions, reducing their interaction with the surrounding medium. The microfibrillated cellulose in the present disclosure has an important advantage over chelated complexes: organic chelates such as EDTA represent up to 95% of the mass of the chelated nutrient ion, making these complexes very inefficient as nutrient ion contributors, whereas microfibrillated cellulose can be present in proportions of less than 5% and still effectively assure availability and solubility of the nutrient ions. This makes MFC a much more logistically favorable “chelator” of nutrient ions, which is an important factor for farmers who apply large quantities of nutrients. Furthermore, the replacement of organic chelates by MFC means that fertilizer compositions can be made which contain as much as 99% absorbable nutrients for the plant, and are 100% biodegradable.

Microfibrillated cellulose retains its structure in a pH range from 1 to 13, meaning the three-dimensional network of microfibrillated cellulose fibers does not collapse and therefore the number of accessible hydroxyl groups is not significantly modified by pH. An interaction between hydroxyl and other polar functional groups on the MFC and the nutrient ions is therefore possible despite external pH modification.

A composition containing water, MFC and a variety of soluble salts containing all the essential and beneficial elements needed by a plant can be generated, wherein all the nutrients are in an available form, creating a single fertilizer apt for hydroponics, fertirrigation or soil or substrate fertilization.

Furthermore, a composition containing MFC and an adequate mixture of stock A and stock B nutrient solutions can be generated, wherein all the nutrients are in an available form, creating a single fertilizer apt for hydroponics, fertirrigation or soil or substrate fertilization.

The inventors have discovered that even in compositions with very low water content, nutrient ions remain available for plant absorption and it is possible to obtain a solid fertilizer with highly beneficial characteristics. One of them is to allow the release of the nutrients on demand of the plant. As the solid fertilizer comes into contact with the soil or substrate solution, it is hydrated from the outside inwards, allowing for the diffusion of nutrients from its interior. As nutrients are absorbed from the soil or substrate by the plant, new nutrients are contributed by the solid fertilizer; the solid fertilizer effectively releases nutrients on demand of the plant. On the other hand, the hydroxyl and other polar functional groups of the MFC compete with the surrounding water in the soil or substrate for interaction with the nutrient ions, so the degree of leaching of nutrients is reduced, because they are withheld by the MFC in the presence of rain or over-watering.

The microfibrillated cellulose as described above may be replaced in the present disclosure by other polymers containing a large quantity of polar groups which provide stabilization for the nutrient ions and are resistant to a wide range of pH values. These alternative polymers must present large surface areas and very high concentrations of polar groups in order to provide the same stabilization properties as MFC. These alternatives may include chemically modified microfibrillated cellulose (for example through oxidation, sulfonation, esterification, etherification, carbonylation, amidation or polymer grafting); other polysaccharides such as pectin, starch, glycogen, chitin, chitosan or hemicellulose; and other polymers with repetitive hydrophilic polar groups along their chain. Although the polar groups exposed along the chains of these alternative polymers may be sufficient to stabilize nutrient ions in a wide range of pH values, however, the biodegradability of each polymer must be considered in order to avoid gradual contamination of the soil. Unmodified microfibrillated cellulose and other unmodified, fibrillated natural biopolymers are preferred over synthetic or chemically modified alternatives.

The assured availability of plant nutrients in a complete and balanced composition thanks to the stabilizing action of the polar groups on the microfibrillated cellulose fibers makes it possible to overcome conditions that limit optimal mineral nutrition in soil and substrate, as well as in hydroponics and fertirrigation. Following are examples of how the present disclosure overcomes the limitations mentioned previously.

Absence of organic matter: the coexistence of nutrient ions with the cellulose microfibers in the composition of the disclosure supplies not only nutrients but also the ion exchange capacity that a soil which is poor in organic matter does not have. Upon addition, the composition does not require organic matter in order to retain the nutrients near the roots and ensure their availability, because the cellulose microfibers provide such a capacity, ensuring the availability of nutritive ions. This property also allows the use of the composition in its solid and liquid versions in substrates such as coco fiber, rockwool or peat, where ion exchange capacities are weak or null. In contrast to traditional fertilizers whose availability or permanence cannot be assured once in contact with the soil or substrate, the present disclosure guarantees not only the supply of nutrients in their available form but their continued availability until uptake even in soils or substrates with low organic matter. Furthermore, MFC is organic matter in itself, therefore it is subject to microbial decomposition and contributes to the organic matter content of the soil until it is naturally decomposed.

Acidity of the medium: the nutrient ions are stabilized by the polar environment generated by the high concentration of accessible hydroxyl and/or polar functional groups attached to the cellulosic chain of the MFC, decreasing their affinity for and competing with free protons or hydroxyl ions in the medium, be it soil or substrate. Because the concentration of accessible hydroxyl and other polar functional groups of the MFC is not affected by varying pH (the three-dimensional fiber network of the MFC does not collapse in a pH range from 1 to 13), nutrient availability within the solid composition is resistant to changes in external pH.

Reactions with soil elements: the nutrient ions are stabilized by the polar environment generated by the high concentration of accessible hydroxyl and/or polar functional groups attached to the cellulosic chain of the MFC, decreasing their affinity for other soil elements and reducing permanent immobilization of nutrients by soil particles.

Excess free ions: the nutrient ions are stabilized by the polar environment generated by the high concentration of accessible hydroxyl and/or polar functional groups attached to the cellulosic chain of the MFC, favoring their localized retention in the composition of the disclosure, avoiding an excess of free ions in the environment of the roots. As the plant absorbs nutrient ions from the soil or substrate solution, the nutrient ions in the composition are released in order to maintain the chemical balance, resulting in a release of nutrients on demand for the plant. Optimal, balanced nutrient ion concentrations in the root environment eliminate the possibility of reduced osmotic potential and plant dehydration, eliminate the possibility of phytotoxicity, and eliminate the possibility of antagonism due to an excess of certain nutrients.

Chemical compatibility: the nutrient ions are stabilized by the polar environment generated by the high concentration of accessible hydroxyl and/or polar functional groups attached to the cellulosic chain of the MFC, making it possible to mix all required mineral salts in a single composition without adverse chemical reactions such as the formation of insoluble compounds, even when incompatible salts are mixed.

Supplying microelements: the microfibrillated cellulose acts as a chelating agent or stabilizer of microelements, allowing the use of inorganic salts in their pure forms as a source of these nutrients, without the need for chelates. In addition to reducing the mass of fertilizer added to the soil, the adverse environmental impact of chelate accumulation in the soil is also avoided.

Reduction of leaching and volatilization: the nutrient ions are stabilized by the polar environment generated by the high concentration of accessible hydroxyl and/or polar functional groups attached to the cellulosic chain of the MFC, favoring their localized retention in the composition of the disclosure and minimizing the leaching and volatilization of nutrient ions.

Explosivity of ammonium nitrate: ammonium nitrate can safely be used as a source of nitrogen in the composition including other essential nutrients and MFC, as the polar environment generated by the high concentration of accessible hydroxyl and/or polar functional groups attached to the cellulosic chain of the MFC stabilizes the nitrate and ammonium ions, rendering the mixture stable and non-explosive.

If environmental conditions are correctly estimated or well controlled, the present disclosure enables the farmer to obtain the highest possible yields of a crop due to precise, requirement-based and available nutrient delivery. A combination of precise nutrition and adequate substrate gives seeds a better chance to thrive and achieve their potential. Substrates such as coco fiber or coco coir, rockwool, sphagnum peat moss, bark, perlite, vermiculite, clay pebbles, mapito and others can be used to support root growth as crops grow. If a volume of substrate large enough to house adequate root growth for a specific crop is combined with a solid or liquid composition of the present disclosure which contains a crop-specific, requirement-based nutritional composition in a previously estimated dosage sufficient to cover an estimated yield, and a seed, bulb, seedling, plant cutting or scrap, the mature crop will reach estimated yields if environmental conditions are assured.

The present disclosure also reduces the adverse environmental impact of fertilizers due to more efficient logistics. Farmers receive one shipment of fertilizer rather than several, and must apply the product only one time upon sowing, saving on operational costs and impact. Furthermore, as the composition is nutritionally balanced, the plant uses nutrients more efficiently, reducing total nutrient application requirements without nutritional deficiencies which may affect yields.

A preferred aqueous composition of the present disclosure includes:

(all percentages in the following descriptions and in the examples correspond to % w/w)

between 0.5% and 90% of water

between 1% and 40% of microfibrillated cellulose (MFC)

between 1% and 55% of calcium nitrate

between 0.01% and 0.5% of magnesium EDTA

between 0.01% and 0.7% of manganese EDTA

between 0.01% and 0.7% of zinc EDTA

between 0.01% and 0.9% iron EDTA

between 0.01% and 0.1% of copper EDTA

between 0.001% and 0.01% sodium molybdate (Dihydrate)

between 0.0001% and 0.001% of cobalt EDTA

between 0.01% and 0.4% of boric acid

between 1% and 12% of potassium nitrate

between 0.5% and 25% of monopotassium phosphate

between 0.5% and 42% of magnesium sulfate

between 0.1% and 11% of potassium sulfate

A most preferred aqueous composition of the present disclosure includes:

18.6 liters of water (68.2%)

6,000 grams of microfibrillated cellulose (22.0%)

1,000 grams of calcium nitrate (3.7%)

12 grams of magnesium EDTA (0.0440%)

20 grams of manganese EDTA (0.0733%)

20 grams of zinc EDTA (0.0733%)

25 grams of iron EDTA (0.0916%)

3 grams of copper EDTA (0.0110%)

0.3 grams of sodium molybdate (Dihydrate) (0.0011%)

0.03 grams of cobalt EDTA (0.0001%)

10 grams of boric acid (0.0366%)

300 grams of potassium nitrate (1.10%)

400 grams of monopotassium phosphate (1.47%)

750 grams of magnesium sulfate (2.75%)

150 grams of potassium sulfate (0.55%)

Another preferred aqueous composition of the present disclosure includes:

between 0.5% and 90% of water

between 1% and 40% of microfibrillated cellulose (MFC)

between 1% and 55% of calcium nitrate or calcium ammonium nitrate

between 1% and 16% of potassium nitrate

between 0.5% and 25% of monopotassium phosphate or dipotassium phosphate

between 0.5% and 42% of magnesium sulfate or magnesium nitrate

between 0.1% and 15% of potassium sulfate

between 0.1% and 30% ammonium nitrate

between 0.05% and 21% monoammonium phosphate or diammonium phosphate

between 0.1% and 16% ammonium sulfate

between 0.01% and 0.7% of manganese sulfate

between 0.01% and 4% of zinc sulfate

between 0.01% and 0.9% iron sulfate

between 0.01% and 0.1% of copper sulfate

between 0.001% and 0.01% ammonium molybdate

between 0.0001% and 0.05% of cobalt sulfate

between 0.01% and 0.4% of boric acid

between 0.0000001% and 0.01% of ammonium selenate

between 0.0000001% and 1% of potassium silicate

between 0.0000001% and 0.01% nickel sulfate

A preferred solid composition for plant nutrition of the present disclosure comprises:

between 0.01% and 20% of water

between 1% and 60% of dry microfibrillated cellulose (MFC)

between 1% and 75% of calcium nitrate or calcium ammonium nitrate

between 1% and 24% of potassium nitrate

between 0.5% and 35% of monopotassium phosphate or dipotassium phosphate

between 0.5% and 60% of magnesium sulfate or magnesium nitrate

between 0.1% and 25% of potassium sulfate

between 0.1% and 45% ammonium nitrate

between 0.1% and 30% monoammonium phosphate or diammonium phosphate

between 0.1% and 25% ammonium sulfate

between 0.01% and 1.5% of manganese sulfate or manganese EDTA

between 0.01% and 6% of zinc sulfate or zinc EDTA

between 0.01% and 1.5% iron sulfate or iron EDTA

between 0.01% and 1% of copper sulfate or copper EDTA

between 0.001% and 0.1% ammonium molybdate or sodium molybdate

between 0.0001% and 0.05% of cobalt sulfate or cobalt EDTA

between 0.01% and 1% of boric acid

between 0.0000001% and 0.01% of ammonium selenate

between 0.0000001% and 1.5% of potassium silicate

between 0.0000001% and 0.01% nickel sulfate

between 0.01% and 1% magnesium EDTA

A most preferred solid composition of the present disclosure comprises:

3% of water

0.9% of dry microfibrillated cellulose (MFC)

45.9% of calcium nitrate or calcium ammonium nitrate

16.6% of potassium nitrate

10.3% of monopotassium phosphate

20.9% of magnesium sulfate

0.7% of potassium sulfate

0.07% of manganese sulfate

0.01% of zinc sulfate

0.96% iron sulfate

0.02% of copper sulfate

0.004 ammonium molybdate

0.0001% of cobalt sulfate

0.13% of boric acid

0.00005% of ammonium selenate

0.00007% of potassium silicate

0.00005% nickel sulfate

A preferred substrate kit of the present disclosure comprises:

90 to 99% w/w inert substrate,

1 to 10% w/w aqueous, semi-solid or solid fertilizer composition of the present invention, and

optionally, a seed, bulb or seedling of a crop corresponding to the fertilizer composition.

Preferably, the inert substrate is selected from the group consisting of gravel, pumice, river sand, volcanic rock, expanded polystyrene, coco fiber or coco coir, rockwool, sphagnum peat moss, bark, perlite, vermiculite, clay pebbles, mapito or any inert growing medium that contains no nutrients, ensures that plant roots have a place to anchor and retains moisture at the same time.

A most preferred substrate kit according to the present disclosure for cultivating lettuce comprises:

10×10×10 cm hydrated rockwool cube,

8 g solid fertilizer for lettuce, as per Example 17 below, and

1 (one) 3-day lettuce seedling.

A most preferred substrate kit of the present disclosure for tomato comprises:

5 liters hydrated inert substrate comprising 80% coco coir and 20% perlite,

20 individual 4-gram solid fertilizer tablets according to the present disclosure for full-cycle tomato, as per Example 12 below, and

1 (one) 10-day tomato seedling.

Another embodiment of the disclosure is a process for preparing a complete concentrated aqueous composition for plant nutrition comprising the step of mixing in water a salt, an oxide, an acid or a chelate of the following nutrient elements: calcium, magnesium, manganese, zinc, iron, copper, molybdenum, cobalt, boron, selenium, silicon, nickel, nitrogen, phosphorous, sulfur and potassium with microfibrillated cellulose (MFC) in order to obtain a complete concentrated aqueous composition for plant nutrition.

Another embodiment of the disclosure is a process for preparing a complete concentrated aqueous composition for plant nutrition comprising the steps of:

preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel,

preparing a concentrated aqueous composition of stock B comprising a salt, an oxide or an acid of the following nutrient elements: nitrogen, phosphorous, sulfur and potassium,

mixing the concentrated aqueous composition of stock B with microfibrillated cellulose (MFC) to obtain a first concentrated aqueous composition, and

mixing the concentrated aqueous composition of stock A with the first concentrated aqueous composition obtained in step c to obtain a complete concentrated aqueous composition for plant nutrition.

Another embodiment of the disclosure is a process for preparing a complete concentrated aqueous composition for plant nutrition comprising the steps of:

preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel in the form of salts or complex chelates,

preparing a concentrated aqueous composition of stock B comprising a salt, an oxide or an acid of the following nutrient elements: nitrogen, phosphorous, sulfur and potassium,

mixing the concentrated aqueous composition stock A with microfibrillated cellulose (MFC) to obtain a first concentrated aqueous composition, and

mixing the concentrated aqueous composition stock B with a first concentrated aqueous composition of step c to obtain a complete concentrated aqueous composition for plant nutrition.

In another embodiment, the present disclosure provides a process for preparing a solid or semisolid composition for plant nutrition comprising the steps of:

mixing in water a salt, an oxide, an acid or a chelate of the following nutrient elements: calcium, magnesium, manganese, zinc, iron, copper, molybdenum, cobalt, boron, selenium, silicon, nickel, nitrogen, phosphorous, sulfur and potassium with microfibrillated cellulose (MFC) in order to obtain a concentrated aqueous composition,

pouring the concentrated aqueous composition of step a into a mold, and

dehydrating the concentrated aqueous composition of step b at a temperature in a range of 50° C. to 130° C., preferably 70° C. for 12 to 72 hours, preferably for 24 hours, up to a humidity content of 0.01 to 20%.

In another embodiment, the present disclosure provides a process for preparing a solid or semisolid composition for plant nutrition comprising the steps of:

preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel,

preparing a concentrated aqueous composition of stock B comprising a salt, an oxide or an acid of the following nutrient elements: nitrogen, phosphorous, sulfur and potassium,

mixing the concentrated aqueous composition stock B and microfibrillated cellulose (MFC) to obtain a first concentrated aqueous composition,

mixing stock A with the first concentrated aqueous composition obtained in step c to obtain a second concentrated aqueous composition,

pouring the second concentrated aqueous composition of step d into a mold, and

dehydrating the concentrated aqueous composition of step e at a temperature in a range of 50° C. to 130° C., preferably 70° C., for 12 to 72 hours, preferably for 24 hours, up to a humidity content of 1 to 20%.

In another embodiment, the disclosure provides a process for preparing a solid or semisolid composition for plant nutrition comprising the steps of:

preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel,

preparing a concentrated aqueous composition of stock B comprising a salt, an oxide or an acid of the following nutrient elements: nitrogen, phosphorous, sulfur and potassium,

mixing the concentrated aqueous composition of stock A and microfibrillated cellulose (MFC) to obtain a first concentrated aqueous composition,

mixing the concentrated aqueous composition of stock B with the first concentrated aqueous composition obtained in step c to obtain a second concentrated aqueous composition,

pouring the concentrated aqueous composition of step d into a mold, and

dehydrating the concentrated aqueous composition of step e at a temperature in a range of 50° C. to 130° C., preferably 70° C., for 12 to 72 hours, preferably for 24 hours, up to a humidity content of 1 to 20%.

Fertilizer compositions which after dehydration contain between 10 and 20% humidity are semisolid, whereas fertilizer compositions which after dehydration contain less than 10% humidity are solid. Fertilizer compositions which contain less than 10% humidity and particularly less than 1% humidity can present very good physical attributes, for example hardness.

In another embodiment, the disclosure provides a process for preparing a substrate kit comprising the steps of:

preparing and optionally hydrating a volume of inert substrate adequate to support the selected crop,

mixing or placing a concentrated aqueous composition or solid fertilizer composition for the selected crop in the appropriate dose for the full crop cycle homogeneously throughout the inert substrate volume, and

optionally placing a seed, bulb or seedling at the adequate depth and placement in the fertilized inert substrate volume.

The following examples are included to more clearly demonstrate the overall nature of the disclosure. These examples are exemplary, not restrictive, of the disclosure.

### EXAMPLES

The following examples show the preparation of concentrated aqueous compositions and solid fertilizer compositions that may contain all the necessary components for a plant. The formulations are not intended to specify the required quantities or to restrict the ingredients used. Their main intention is to show the preparation of a concentrated aqueous composition and a solid fertilizer composition of this disclosure.

The following examples also include demonstrations of the effectiveness of concentrated aqueous compositions and solid fertilizer compositions in different crops. The examples are not intended to limit or restrict the crops for which the compositions can be used. Concentrated aqueous compositions or solid fertilizer compositions can be formulated for every and any crop.

The following examples also include the demonstration of a combination of substrate, aqueous compositions or solid fertilizer compositions and crop seeds to achieve estimated yields. The examples are not intended to limit or restrict the crops or substrates for which the compositions can be used. Concentrated aqueous compositions or solid fertilizer compositions can be formulated for and used in combination with every and any crop and every and any substrate.

### Example 1

Example 1 illustrates the preparation of a concentrated aqueous suspension according to the present disclosure.

In order to prepare 10 liters of stock A, the following elements were mixed into 9.3 liters of water at 77° F. and neutral pH (the reason that 9.3 liters of water are added is to get 10 liters of stock A, as salts provide approximately 700 cc of the volume):

1,000 grams of calcium nitrate

12 grams of magnesium EDTA

20 grams of manganese EDTA

20 grams of zinc EDTA

25 grams of iron EDTA

3 grams of copper EDTA

0.3 grams of sodium molybdate (Dihydrate)

0.03 grams of cobalt EDTA

10 grams of boric acid

The weight of the resulting 10 liters of stock A is 10,390 grams.

In order to prepare 10 liters of stock B, the following elements were mixed into 9.3 liters of water at 77° F. and neutral pH (the reason that 9.3 liters of water are added is to get 10 liters of stock B since salts provide approximately 700 cc of the volume):

300 grams of potassium nitrate

400 grams of monopotassium phosphate

750 grams of magnesium sulfate

150 grams of potassium sulfate

The weight of the resulting 10 liters of stock B is 10,900 grams.

An amount of 27.3 kilos of concentrated aqueous suspension of stock A and B in microfibrillated cellulose were prepared. The reason that 27.3 kilos are prepared is because the proportions, in this formulation, are 6 parts of microfibrillated cellulose (MFC) for every 10 parts of stock A (10,390 grams) and 10 parts of stock B (10,900 grams), which results in the aforementioned quantity.

Six kilos of microfibrillated cellulose (MFC) were mixed into 10 liters of stock A and stirred manually for 5 minutes. Then, 10 liters of stock B were added to the resulting solution and stirred manually for 5 minutes. The resulting solution has the initial composition of stock A and stock B as well as the microfibrillated cellulose (MFC), with a pH of 3.4. This means:

18.6 liters of water (68.2%)

6,000 grams of microfibrillated cellulose (22.0%)

1,000 grams of calcium nitrate (3.7%)

12 grams of magnesium EDTA (0.0440%)

20 grams of manganese EDTA (0.0733%)

20 grams of zinc EDTA (0.0733%)

25 grams of iron EDTA (0.0916%)

3 grams of copper EDTA (0.0110%)

0.3 grams of sodium molybdate (Dihydrate) (0.0011%)

0.03 grams of cobalt EDTA (0.0001%)

10 grams of boric acid (0.0366%)

300 grams of potassium nitrate (1.10%)

400 grams of monopotassium phosphate (1.47%)

750 grams of magnesium sulfate (2.75%)

150 grams of potassium sulfate (0.55%)

The weight of the suspension is 27,290 grams.

### Example 2

Example 2 illustrates the mixture of stock A and stock B with and without precipitates. One hundred (100) cc of the obtained stock A and 100 cc of the obtained stock B were mixed at 77° F. The mixture was stirred and after 3 minutes the emergence of a precipitate was observed. Thirty minutes later the mixture was stirred again and 2 minutes after that the precipitate was still present, thus confirming that the precipitate does not re-dissolve.

### Example 3

Example 3 illustrates the mixture of stock A and MFC, then the addition of stock B. One hundred (100) cc of the obtained stock A were mixed into 60 grams of microfibrillated cellulose (MFC). The mixture was stirred manually, and then 100 cc of the obtained stock B were immediately added. After 3 minutes, no precipitate emergence was observed. The sample was monitored 24 hours later, 48 hours later and even 90 days later but no modifications were found in its appearance.

### Example 4

Example 4 illustrates the mixture of stock B and MFC, then the addition of stock A. In this example, the order of the stocks in the preparation of the aqueous suspension was exchanged. One hundred (100) cc of the obtained stock B were mixed into 60 grams of microfibrillated cellulose (MFC). The mixture was manually stirred and then 100 cc of the obtained stock A were added. After 3 minutes no precipitate was seen emerging. The sample was monitored 24 hours later, 48 hours later and even 90 days later but no modifications were found in its appearance.

### Example 5

Example 5 aims to demonstrate that there is no evidence of toxicity in the use of microfibrillated cellulose (MFC) when it is used in a nutrient solution. Three, identical, small hydroponic floating systems were prepared where two lettuce specimens were grown.

The hydroponic floating system consisted of 20 liter trays where two seedlings of lettuce were laid in each one. The trays had a flat bar of polystyrene to support the seedlings and each of them had two holes that enabled the roots to reach the water contained in the trays.

Hydroponic system number 1 was fed with stock A and stock B nutrient solutions, and no microfibrillated cellulose (MFC) was added. Hydroponic system number 2 was fed with a concentrated aqueous suspension of stock A and B in microfibrillated cellulose (MFC) having a microfibrillated cellulose (MFC) concentration of 23%. Hydroponic system number 3 was fed with a concentrated aqueous suspension of stock A and B in microfibrillated cellulose (MFC), having a microfibrillated cellulose (MFC) concentration of 80%.

The amount of solution and/or aqueous suspension added in the three systems had the same electrical conductivity in each case, ensuring the same provision of salts in each of them (electrical conductivity is a measure of the amount of dissolved solids per unit of volume).

The targeted electrical conductivity varied from week to week, depending on the requirements of the lettuce plants in their lifecycle, having 350 ppm in week 1; 700 ppm in week 2; 1,050 ppm in week 3 and 1,400 ppm in week 4.

After week 4 all the lettuce plants had showed equal growth and reached a weight ranging between 270 and 280 grams each.

Thus, we can conclude that microfibrillated cellulose (MFC) allows for the availability of salts for plants as well as the right absorption of nutrients because the growth of specimens studied did not reveal significant variations.

### Example 6

Example 6 shows how microfibrillated cellulose (MFC) prevents calcium sulfate from precipitating even when solutions of calcium nitrate and sulfates in their highest possible concentration at 77° F. and neutral pH are mixed. Two samples were tested.

In the first sample, a control sample, three salt dilutions at the highest possible concentration at 77° F. and neutral pH were mixed, in this order: 180 cc of water (180 cc of water was added so as to equate the volumes in the samples, water in the first one and microfibrillated cellulose in the second one), 100 cc of calcium nitrate solution (1,200 grams in 1 liter of water), 100 cc of potassium sulfate solution (120 grams in 1 liter of water) and 100 cc of manganese sulfate solution (710 grams in 1 liter of water). After mixing them mechanically, a precipitate of 192 grams of calcium sulfate was observed.

In the second sample, three salt dilutions at the highest possible concentration at 77° F. and neutral pH were mixed in microfibrillated cellulose (MFC), following this order: 100 cc of calcium nitrate solution (1,200 grams in 1 liter of water) in 60 grams of microfibrillated cellulose (MFC), 100 cc of potassium sulfate solution (120 grams in 1 liter) in 60 grams of microfibrillated cellulose (MFC), and finally 100 cc of manganese sulfate solution (710 grams in a liter) in 60 grams of microfibrillated cellulose (MFC). The three suspensions were mixed altogether. There were no signs of a precipitate after 48 hours.

### Example 7

Example 7 shows that microfibrillated cellulose (MFC) makes it possible to elaborate suspensions of homogeneously distributed salts that contain solids in a much higher proportion than the quantity of salts that could be contained in a water solution of the same volume. Two sample tests were run.

In the first sample, a control sample, potassium sulfate was added in an amount that exceeded twice its solubility in water at 77° F. and neutral pH (111 g/L). More specifically, 28.8 grams of potassium sulfate were mixed in 130 cc of water at 77° F. The result was stirred manually and immediately after that a precipitate of potassium sulfate was noted.

The second sample consisted of the same amount of potassium sulfate contained in the control sample (that is, 28.8 grams) that was added into a suspension of the same volume (130 cc) with microfibrillated cellulose (MFC) at 23% (30 grams of microfibrillated cellulose in 100 cc of water). The result was stirred manually and after 5 minutes no decantation of potassium sulfate was observed. The sample was monitored 24 hours later, 48 hours later and even 90 days after without having observable modifications in its appearance.

### Example 8

Example 8 illustrates an alternative process for the preparation of a liquid composition according to the present disclosure. A starter fertilizer composition was applied in small quantities close to the seed during sowing. Its purpose was to aid the development of the plants in early stages by offering essential nutrients in accessible places for the roots. The main elements of the composition usually were phosphorus and sulfur.

In this example, a formulation for a starter fertilizer was prepared by directly mixing the respective salts with water and MFC, without the need for the preparation of stock A and stock B solutions. For a starter formulation, 435 mL of water at 25° C. and neutral pH were mixed with 43.5 g of microfibrillated cellulose (MFC) and dispersed until the suspension was homogeneous. Subsequently, the following salts were added, stirring constantly:

| Ingredient | Mass (g) |
|---|---|
| Calcium nitrate | 170 |
| Monopotassium phosphate | 174 |
| Magnesium sulfate heptahydrate | 357 |
| Monoammonium phosphate | 313 |
| Boric acid | 2 |
| Zinc sulfate | 28 |

A homogeneous suspension was achieved. The elemental composition of this starter formulation is (% w/v):

Nitrogen: 7.4%

Phosphorus: 12%

Potassium: 6.1%

Sulphur: 5.1%

Calcium: 3.8%

Magnesium: 4.3%

Zinc: 1%

Boron: 0.05%

### Example 9

Example 9 illustrates that higher yields can be achieved using starter fertilizer with MFC as compared to traditional fertilizers. This experiment aimed to evaluate the yield of maize fertilized with a phosphorus-based starter fertilizer described in Example 8 according to the present disclosure, as compared to a commercial starter fertilizer considered premium treatment in the market. The experiment was conducted in Pergamino, Buenos Aires, Argentina, a locality renowned for its high yields, by the Institute for National Agricultural Technology (INTA). A randomized block design with four repetitions was used, with a 75,000 plant per hectare sowing density. The treatments are outlined below:

Treatment 1 (T1): control treatment with 217 kg per hectare urea (46-0-0) pre-sowing (the standard fertilization in the area) with no application of starter fertilizer.

Treatment 2 (T2): phosphorus-based starter treatment described in Example 8 with a 70 liter per hectare dosage incorporated pre-sowing, plus 217 kg per hectare urea.

Treatment 3 (T3): premium commercial starter treatment with a 80 kg per hectare dosage incorporated pre-sowing, plus 217 kg per hectare urea.

The elemental composition of the starter fertilizers was the following:

| | N | P | S | K | Ca | Mg | Zn | B |
|---|---|---|---|---|---|---|---|---|
| Example 8 starter | 7.4 | 12 | 5.1 | 6.1 | 3.8 | 4.3 | 1 | 0.05 |
| fertilizer composition | | | | | | | | |
| with MFC (% w/v) | | | | | | | | |
| Premium commercial | 10 | 17.3 | 10 | | | | 1 | |
| starter fertilizer (%w/w) | | | | | | | | |

The total amount of each element applied in each treatment, and the final yields are as follows:

| | Applied nutrients (kg/ha) | | | | | | | | Yield |
|---|---|---|---|---|---|---|---|---|---|
| Treatment | N | P | S | K | Ca | Mg | Zn | B | (kg/ha) |
| T1 | 99.8 | | | | | | | | 8,910.7 |
| T2 | 104.9 | 8.4 | 3.6 | 4.3 | 2.7 | 3.0 | 0.7 | 0.035 | 11,666.7 |
| T3 | 107.8 | 13.8 | 8 | | | | 0.8 | | 11,444.0 |

The application of starter Treatment 2 with a 70 liter per hectare dosage achieved the highest yield, with 40% less applied elemental phosphorus, 55% less applied elemental sulfur and 12% less applied elemental zinc than treatment 3. This demonstrates that the use of the applied elements in treatment 2 was significantly more efficient than treatment 3, due to the balanced nature of the nutritional composition of the starter fertilizer of Example 8. The starter product with MFC increases nutrient efficiency and reduces the total amount of fertilizer applied, reducing possible losses of nutrients to the environment.

### Example 10

Example 10 illustrates higher yields using starter fertilizer composition with MFC as compared to traditional fertilizers in acidic soils. This experiment aimed to evaluate the yield of maize fertilized with a phosphorus-based starter fertilizer described in Example 8 according to the present disclosure, compared to a commercial starter fertilizer considered premium treatment in the market, in acidic soils. The experiment was conducted in Mercedes, Corrientes, Argentina, a locality renowned for its acidic soils, by a respectable local agronomist. The pH of the topsoil in this experiment was 5.2 which is classified as strongly acidic by the INTA. A randomized block design with four repetitions was used, with a 75,000 plant per hectare sowing density. The treatments are outlined below:

Treatment 1 (T1): control treatment with 100 kg per hectare urea (46-0-0) and 60 kg per hectare potassium chloride pre-sowing (the standard fertilization in the area) with no application of starter fertilizer.

Treatment 2 (T2): phosphorus-based starter treatment described in Example 8 according to the present disclosure with a 180 liter per hectare dosage incorporated pre-sowing, plus 100 kg per hectare urea and 60 kg per hectare potassium chloride.

Treatment 3 (T3): premium commercial starter treatment with a 100 kg per hectare dosage incorporated pre-sowing, plus 100 kg per hectare urea and 60 kg per hectare potassium chloride.

The elemental composition of the starter fertilizers was the same as in Example 9. The total amount of each element applied in each treatment, and the final yields are as follows:

| | Applied nutrients (kg/ha) | | | | | | | | Yield |
|---|---|---|---|---|---|---|---|---|---|
| Treatment | N | P | S | K | Ca | Mg | Zn | B | (kg/ha) |
| T1 | 46 | | | 31 | | | | | 2785 |
| T2 | 53.4 | 13.1 | 1.3 | 36.8 | 3.3 | 4.1 | 1 | 0.01 | 7582 |
| T3 | 56 | 17.3 | 10 | 31 | | | 1 | | 7251 |

The yield achieved with treatment 2 was significantly higher than with commercial treatment 3, meaning the starter fertilizer with MFC outperforms traditional fertilizers in acidic soils. The pH of the soil did not affect the availability of nutrient ions in the starter fertilizer with MFC.

The application of starter treatment 2 with a 180 liter per hectare dosage achieved the highest yield, with 25% less applied elemental phosphorus and 87% less applied elemental sulfur than treatment 3. This demonstrates that the use of the applied elements in treatment 2 was significantly more efficient than treatment 3. The starter product with MFC increases nutrient efficiency and reduces the total amount of fertilizer applied, reducing possible losses of nutrients to the environment, even in acidic soils.

### Example 11

Example 11 aims to demonstrate the reduced leaching of nutrients from a liquid composition with MFC according to the present disclosure as compared to traditional fertilizer. 5×5×5 cm cubes of inert and nutrient-free rockwool were soaked in water overnight and injected with 1 mL of a suspension of 50 g MFC, 190 g monopotassium phosphate and 151 g distilled water. Another set of rockwool cubes were injected with 1 mL of a mixture of 190 g of monopotassium phosphate and 200 g of distilled water with no MFC content.

Distilled water was poured in 15 mL fractions on top of the rockwool cubes and the leachate from each cube was weighed and its electrical conductivity measured. Fractions of approximately 15 mL of leachate were collected until the electrical conductivity was 0. The electrical conductivity of monopotassium phosphate had previously been calibrated.

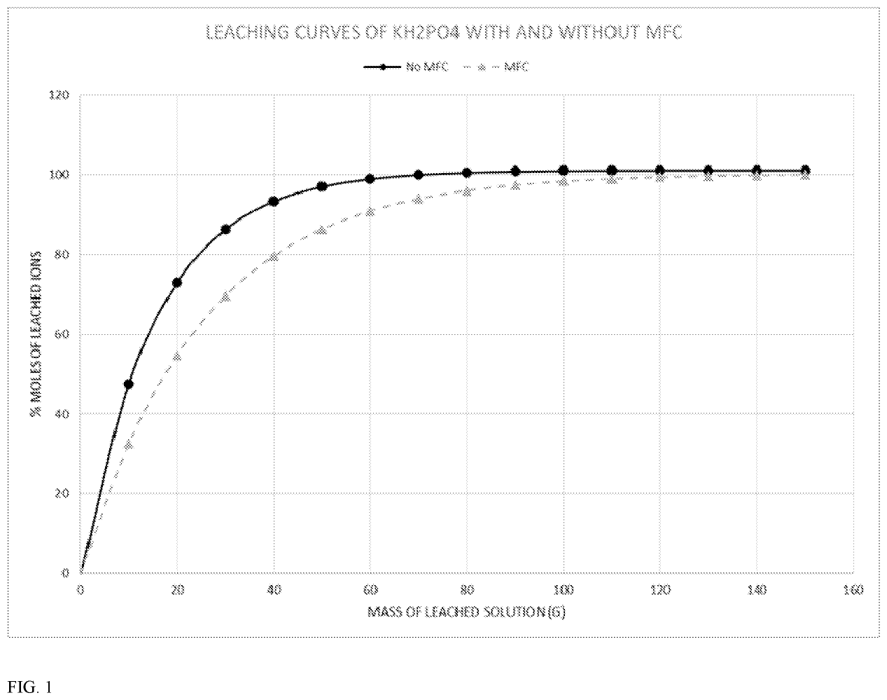

FIG. 1 is a graph of accumulated moles of leached potassium and dihydrogen phosphate ions in solution during leaching from the rockwool substrate with and without MFC retention. The resulting leaching curves were fitted with exponential equations. The equations for the exponential fits were: (a) y=101.2-102 exp(−0.064×) without MFC; and (b) y=100.3-101 exp(−0.040×) with MFC. The rate of leaching (exponential coefficient) of monopotassium phosphate in the suspension with MFC (0.040) was 62% that of the mixture of monopotassium phosphate and water alone (0.064). In practice, this means a suspension with monopotassium phosphate and MFC needs greater than 60% more excess rainfall to completely wash its content than monopotassium sulfate alone. Reduced leaching in the suspension with MFC is due to the high retention of ions by the MFC. The reduced leaching in this example can be considered exemplary for all nutrient salts, and the same behavior can be expected for balanced fertilizer compositions.

### Example 12

Example 12 illustrates the preparation of a solid-consistency fertilizer according to the present disclosure. 1,000 grams of the concentrated aqueous suspension of stock A and B in microfibrillated cellulose (MFC) as described in Example 1 was poured into granular-shaped molds of 10 cm3, each of them containing 12 grams of suspension, and were placed in a dehydrator oven at 70° C. for 24 hours. The final result of this process was a product with a solid consistency. In each mold, a 4 gram tablet was obtained, which implies a loss of 8 grams of water. Assuming that the microfibrillated cellulose (MFC) lost 50% of its humidity and knowing that its fiber ratio is 15%, the resulting composition of each tablet is:

| Ingredient | Percentage (%) |
|---|---|
| Water | 10.00 |
| Microfibrillated cellulose | 50.65 |
| Calcium nitrate | 14.65 |
| Potassium nitrate | 4.39 |
| Monopotassium phosphate | 5.86 |
| Magnesium sulfate | 10.99 |
| Potassium sulfate | 2.19 |
| Magnesium EDTA | 0.176 |
| Manganese EDTA | 0.293 |
| Zinc EDTA | 0.293 |
| Iron EDTA | 0.366 |
| Copper EDTA | 0.044 |
| Sodium molybdate (dihydrate) | 0.044 |
| Boric acid | 0.147 |
| Cobalt EDTA | 0.0044 |

### Example 13

Example 13 illustrates nutrition of a tomato specimen using the concentrated aqueous suspension in its solid form according to the present disclosure. A tomato specimen was grown using for its nutrition only the concentrated aqueous suspension in its solid from, obtained as described in Example 12. A thin layer of leca was first placed in an 11 liter pot to facilitate drainage, and then filled with an inert, nutrient-free substrate (peat). Then, 12 tablets obtained as described in Example 12 were placed evenly distributed throughout the pot. The pot was watered according to its demand, water being the only input added during the whole cycle. In a 105-day cycle, the plant produced 43 tomatoes with a total weight of 4.9 kilos. The plant showed a normal size with a suitable growth speed and the presence of healthy leaves in the upper part of its stem.

This experiment demonstrates that the nutrients were effectively released at the plant's request throughout the cycle. Healthy leaves with no nutrient deficiency symptoms show that all the nutrients were in an available form for the plant.

### Example 14

Example 14 demonstrates a solid fertilizer composition according to the present invention containing a nutritional balance for the complete cycle of maize. The nutritional balance is based on the known absorption requirements of maize. MFC in an amount of 132 g was dispersed in 667 mL of water until a homogeneous suspension was achieved. The following salts were then incorporated under constant mixing:

| Ingredient | Mass (g) |
|---|---|
| Ammonium nitrate | 166 |
| Calcium nitrate | 72 |
| Potassium nitrate | 98 |
| Monopotassium phosphate | 151 |
| Magnesium sulfate heptahydrate | 70 |
| Magnesium nitrate hexahydrate | 100 |
| Manganese sulfate | 0.51 |
| Zinc sulfate | 1.08 |
| Iron sulfate | 5.26 |
| Copper sulfate | 0.27 |
| Boric acid | 0.18 |
| Ammonium molybdate | 0.03 |
| Cobalt sulfate | 0.0005 |
| Ammonium selenate | 0.0002 |
| Potassium silicate | 0.0015 |
| Nickel sulfate | 0.0002 |

Approximately 9 g of liquid suspension for maize was then poured into 7 mL cylindrical molds and dehydrated in an oven at 70° C. for 20 hours. The tablets were removed from the molds and returned to the oven for a further 4 hours. The final weight of each tablet was approximately 4.2 g.

The composition of the solid tablets was calculated to be:

| Ingredient | Mass (g) |
|---|---|
| Water | 5 |
| Dry microfibrillated cellulose fibers | 13.2 |
| Ammonium nitrate | 166 |
| Calcium nitrate | 72 |
| Potassium nitrate | 98 |
| Monopotassium phosphate | 151 |
| Magnesium sulfate heptahydrate | 70 |
| Magnesium nitrate hexahydrate | 100 |
| Manganese sulfate | 0.51 |
| Zinc sulfate | 1.08 |
| Iron sulfate | 5.26 |
| Copper sulfate | 0.27 |
| Boric acid | 0.18 |
| Ammonium molybdate | 0.03 |
| Cobalt sulfate | 0.0005 |
| Ammonium selenate | 0.0002 |
| Potassium silicate | 0.0015 |
| Nickel sulfate | 0.0002 |

The elemental composition of the final tablets was (% w/w):

Nitrogen: 12.6%

Phosphorus: 4.5%

Potassium: 10.8%

Sulphur: 0.24%

Calcium: 1.8%

Magnesium: 2.2%

Iron: 0.14%

Manganese: 0.02%

Boron: 0.004%

Zinc: 0.05%

Copper: 0.009%

Molybdenum: 0.002%

Cobalt: 0.00001%

Selenium: 0.00001%

Silicon: 0.00004%

Nickel: 0.000006%

### Example 15

Example 15 illustrates the performance of a solid fertilizer composition according to the present disclosure as compared to standard hydroponic nutrient solutions. The experiment sought to compare the performance of the solid composition presented in Example 14 against a standard hydroponic nutrient solution in inert substrates. Two treatments were designed, with each one of them consisting of 10 corn plants in pots with an inert substrate. Treatment 1 (T1) consisted of the solid fertilizer composition of Example 14 in the amount necessary to supply the nutritional requirements of the entire cycle (16 capsules totaling 9 grams of elemental nutrients) of the solid composition, and was irrigated only with water during the 50 days of testing. Treatment 2 (T2) consisted of the inert substrate which was irrigated with a hydroponic fertilizer in such a way to ensure the provision of all the nutrients required by the corn in its life cycle.

At 50 days after sowing, the yields obtained were 0.100 kg/plant for T1 and 0.094 kg/plant for T2. No significant differences between treatments were observed. No toxicity or nutrient deficiencies were observed in either treatment; in particular, no nitrogen deficiencies were observed in T1, meaning nitrogen was not lost due to leaching or volatilization. Also, normal variations in the pH of irrigation water did not affect the availability of nutrients in T1. The nutrients provided by the solid composition of the disclosure were released on demand of the plant during the whole cycle without expressing any nutritional deficiency or toxicity effects.

### Example 16

Example 16 illustrates extremely high yields in hemp compared to premium fertilizer. A field assay was conducted in Paysandú, Uruguay, to test the performance of the present disclosure on the dry yield and cannabidiol (CBD) content of industrial hemp. Soil in the region is highly fertile, with good phosphorus and potassium content. Seeds were germinated in trays and transplanted after 10 days of emerging. The treatments used were:

Treatment 1: water soluble premium commercial nutrition for vegetative and reproductive stages was applied three times a week by fertirrigation.

Treatment 2: specialized aqueous compositions according to the present disclosure for vegetative and reproductive stages were applied three times a week by fertirrigation.

Treatment 3: a solid composition according to the present disclosure for the whole cycle was applied upon transplant and only irrigated with water for the duration of the assay.

The ingredient lists of the compositions used in Treatments 2 and 3 were the following:

| | Mass (g) | | | |
|---|---|---|---|---|
| | Liquid | Liquid re- | | Solid com- |
| | vegetative | productive | | position |
| | stage com- | stage com- | Solid com- | after |
| Ingredient | position | position | position | dehydration |
| Water | 535 | 667 | 2,000 | 15 |
| MFC | 21.7 | 33.3 | 250 | 25 (dry) |
| Potassium nitrate | 136 | 211 | 408 | 408 |
| Monopotassium | 90 | 76 | 452 | 452 |
| phosphate | | | | |
| Magnesium sulfate | 72 | 169 | 538 | 538 |
| Potassium sulfate | 0 | 0 | 48 | 48 |
| Calcium nitrate | 147 | 106 | 349 | 349 |
| Ammonium nitrate | 410 | 111 | 440 | 440 |
| Iron sulfate | 4.1 | 2.9 | 10.2 | 10.2 |
| Manganese sulfate | 1.2 | 0.5 | 2.4 | 2.4 |
| Boric acid | 0.45 | 0.6 | 2.2 | 2.2 |
| Zinc sulfate | 0.45 | 0.3 | 1.3 | 1.3 |
| Copper sulfate | 0.09 | 0.1 | 0.2 | 0.2 |
| Ammonium | 0.10 | 0.031 | 0.2 | 0.2 |
| molybdate | | | | |
| Cobalt sulfate | 0.0010 | 0.0008 | 0.0029 | 0.0029 |
| Ammonium selenate | 0.0008 | 0.0005 | 0.0019 | 0.0019 |
| Potassium silicate | 0.0018 | 0.0013 | 0.0046 | 0.0046 |
| Nickel sulfate | 0.0015 | 0.0011 | 0.0040 | 0.0040 |

Solid tablets were made as per the procedure described in Example 12 and 65 tablets were applied evenly in the soil at the time of transplant at a depth of 5 to 10 cm, 10 to 15 cm away from the plant. The elemental composition of each treatment of the present disclosure was the following:

| | % w/v | | % w/w |
|---|---|---|---|
| | Liquid vegetative | Liquid reproductive | Solid |
| Element | stage composition | stage composition | composition |
| N | 18.88 | 8.43 | 11.4 |
| P | 2.02 | 1.69 | 4.3 |
| K | 7.87 | 10.27 | 13.1 |
| S | 1.02 | 2.25 | 3.4 |
| Ca | 2.81 | 2.01 | 2.8 |
| Mg | 0.9 | 1.69 | 2.3 |
| Fe | 0.08 | 0.06 | 0.08 |
| Mn | 0.04 | 0.02 | 0.03 |
| B | 0.01 | 0.01 | 0.016 |
| Zn | 0.02 | 0.01 | 0.019 |
| Cu | 0.002 | 0.002 | 0.002 |
| Mo | 0.006 | 0.002 | 0.005 |
| Co | 0.00002 | 0.00002 | 0.00002 |
| Se | 0.00003 | 0.00002 | 0.00003 |
| Si | 0.00003 | 0.00002 | 0.00003 |
| Ni | 0.00003 | 0.00002 | 0.00003 |

The total supplied elements for all treatments during the whole crop cycle and the results of the experiment were:

| | Mass (g) | | |
|---|---|---|---|
| Element | Treatment 1 | Treatment 2 | Treatment 3 |
| N | 63.0 | 61.5 | 38.8 |
| P | 15.7 | 17.5 | 14.7 |
| K | 67.2 | 43.6 | 44.6 |
| S | 40.8 | 10.8 | 11.6 |
| Ca | 0.00 | 11.8 | 9.5 |
| Mg | 5.1 | 7.0 | 7.8 |
| Fe | 0.21 | 0.34 | 0.27 |
| Mn | 0.21 | 0.16 | 0.102 |
| B | 0.042 | 0.06 | 0.055 |
| Zn | 0.084 | 0.09 | 0.065 |
| Cu | 0.084 | 0.009 | 0.0068 |
| Mo | 0.004 | 0.025 | 0.0170 |
| Co | 0.0 | 0.00009 | 0.000068 |
| Se | 0.0 | 0.00015 | 0.000102 |
| Si | 0.0 | 0.00015 | 0.000102 |
| Ni | 0.0 | 0.00015 | 0.000102 |
| Plant height (cm) | 44.26 | 77.66 | 82.6 |
| Number of nodes | 14.4 | 21.93 | 28.4 |
| Final chlorophyll content | 54.58 | 74.88 | 78.6 |
| (μg/cm tissue) | | | |
| Yield (g/plant) | 104 | 238 | 176 |
| CBD (g/plant) | 10.0 | 26.4 | 17.4 |

Both Treatments 2 and 3 presented huge yield increases of approximately 230% and 169%, respectively, compared to Treatment 1, and CBD content increases of 263% and 173%, respectively, compared to Treatment 1. Also, plants in Treatments 2 and 3 were over 1.7 times taller, had over 1.5 times as many nodes, and presented approximately 1.4 times as much chlorophyll as Treatment 1, evidencing larger and healthier plants. Importantly, Treatment 3 achieved very high yields and high CBD production with only 62% nitrogen and 66% potassium as compared to the premium commercial treatment, which evidences high efficiency of nutrient delivery in the solid composition. Furthermore, it is noteworthy that the high yields could be partly due to the provision of available calcium, an element which is entirely missing in the premium commercial treatment and whose availability is assured in the present disclosure.

### Example 17

Example 17 illustrates the preparation of a substrate-aqueous fertilizer composition and a substrate-solid fertilizer composition for precise yield obtainment of lettuce. An aqueous suspension was prepared according to the following recipe for the full crop cycle nutritional requirements of lettuce:

| | | Liquid fertilizer |
|---|---|---|
| | Liquid fertilizer | composition for preparing |
| | composition for | a solid fertilizer for |
| Ingredient | lettuce (mass, g) | lettuce (mass, g) |
| Water | 526 | 526 |
| MFC | 26.3 | 91 |
| Potassium nitrate | 166 | 166 |
| Monopotassium | 103 | 103 |
| phosphate | | |
| Magnesium sulfate | 209 | 209 |
| Potassium sulfate | 7 | 7 |
| Calcium nitrate | 459 | 459 |
| Iron sulfate | 9.6 | 9.6 |
| Manganese sulfate | 0.7 | 0.7 |
| Boric acid | 1.3 | 1.3 |
| Zinc sulfate | 0.13 | 0.13 |
| Copper sulfate | 0.18 | 0.18 |
| Ammonium | 0.04 | 0.04 |
| molybdate | | |
| Cobalt sulfate | 0.0009 | 0.0009 |
| Ammonium selenate | 0.0005 | 0.0005 |
| Potassium silicate | 0.0007 | 0.0007 |
| Nickel sulfate | 0.0005 | 0.0005 |

A 300 g lettuce head composed of 95% w/w water and, of the remaining 5%, 5% w/w nitrogen, contains approximately 0.75 g nitrogen. The aqueous composition for lettuce contains 6.35% w/w nitrogen; therefore, 11.8 g of aqueous composition contains 0.75 g nitrogen. The solid composition for lettuce contains 5.99% w/w nitrogen before dehydration and 9.39% w/w nitrogen after dehydration as described in Example 12; therefore, 7.99 g of solid composition for lettuce contains 0.75 g nitrogen.

Two 20 cm×20 cm×7 cm rockwool cubes were hydrated for 24 hours in water and drained to remove excess water.

For the preparation of the rockwool cube with aqueous fertilizer composition, the lettuce seedling was placed in a small cavity in the center of the cube after removing a small amount of rockwool to accommodate the seedling. 11.8 g of aqueous composition was injected into a rockwool cube with a syringe at four points situated at 3 cm depth and 5 cm distance from the seedling. For the preparation of the rockwool cube with solid fertilizer composition, 7.99 g (approximately 2 tablets) are located at 3 cm depth in the center of the cube, covered with a thin layer of rockwool and the lettuce seedling placed on top. Thereafter, the cubes were maintained moist during the whole crop cycle (approximately 35 days) until harvest of 300 g fresh weight lettuce heads.

### Example 18

Example 18 illustrates the preparation of an aqueous composition for the complete cycle of olives. The following ingredients were mixed according to the same procedure as Example 8:

| Ingredient | Mass (g) |
|---|---|
| Water | 43 |
| MFC | 2.3 |
| Calcium nitrate | 21.4 |
| Potassium nitrate | 9.9 |
| Magnesium sulfate | 5.2 |
| Potassium sulfate | 2.2 |
| Ammonium nitrate | 11.5 |
| Monoammonium phosphate | 2.6 |
| Ammonium sulfate | 0.8 |
| Manganese sulfate | 0.07 |
| Zinc sulfate | 0.06 |
| Iron sulfate | 0.65 |
| Copper sulfate | 0.01 |
| Boric acid | 0.12 |
| Ammonium molybdate | 0.004 |
| Cobalt sulfate | 0.00006 |
| Ammonium selenate | 0.00003 |
| Potassium silicate | 0.00007 |
| Nickel sulfate | 0.00006 |

A liquid suspension with a nutritional balance suitable for the total cycle of an olive crop was obtained.

### Example 19

Example 19 illustrates higher yields using a full-cycle maize fertilizer with MFC as compared to traditional fertilizers. This experiment aimed to evaluate the yield of maize fertilized with a nitrogen-based, full-cycle fertilizer according to the present disclosure, as compared to a commercial fertilizer considered premium treatment in the market. The nitrogen-based, full-cycle maize fertilizer was prepared with the following ingredients and mixed according to the procedure described in Example 8:

| Ingredient | Mass (g) |
|---|---|
| Water | 41 |
| MFC | 2.2 |
| Calcium nitrate | 3.5 |
| Monopotassium phosphate | 3.7 |
| Magnesium sulfate | 8.2 |
| Ammonium nitrate | 31.9 |
| Monoammonium phosphate | 7.8 |
| Manganese sulfate | 0.04 |
| Zinc sulfate | 0.61 |
| Iron sulfate | 0.41 |
| Copper sulfate | 0.02 |
| Boric acid | 0.17 |
| Ammonium molybdate | 0.0003 |
| Cobalt sulfate | 0.00004 |
| Ammonium selenate | 0.00002 |
| Potassium silicate | 0.00005 |
| Nickel sulfate | 0.00004 |

A liquid suspension with a nutritional balance suitable for corn was obtained, focusing on a high nitrogen provision to supplement low soil nitrogen levels. The percent of elemental nitrogen in this formula is 12.6%. The experiment was carried out in Pergamino, Buenos Aires, Argentina, a locality renowned for its high yields, by the Institute for National Agricultural Technology (INTA). A randomized block design with four repetitions was used, with an 80,000 plant per hectare sowing density. The treatments are outlined below:

Treatment 1 (T1): control treatment with 200 kg per hectare urea was broadcast upon sowing.

Treatment 2 (T2): nitrogen-based, full-cycle fertilizer treatment with a 220 liter per hectare dosage was incorporated next to the seed upon sowing.

Treatment 3 (T3): premium commercial fertilizer treatment with a 100 kg per hectare dosage was incorporated next to the seed upon sowing and 200 kg per hectare urea was broadcast upon sowing.

The elemental composition of the fertilizer treatments was the following:

| | Nitrogen-based full-cycle fertilizer | Premium commercial |
|---|---|---|
| Element | composition with MFC (% w/v) | fertilizer (% w/w) |
| N | 15.3 | 10 |
| P | 3.16 | 17.3 |
| S | 0.31 | 10 |
| K | 1.27 | |
| Ca | 0.82 | |
| Mg | 0.98 | |
| Fe | 0.094 | |
| Mn | 0.016 | |
| B | 0.003 | |
| Zn | 0.256 | 1 |
| Cu | 0.0075 | |
| Mo | 0.000016 | |
| Co | 0.0001 | |
| Se | 0.000009 | |
| Si | 0.000009 | |
| Ni | 0.0001 | |

The total amount of each element applied in each treatment in kg per hectare and the final yields are as follows:

| Element | T1 | T2 | T3 |
|---|---|---|---|
| N | 92 | 33.7 | 102 |
| P | | 7.0 | 17.3 |
| S | | 0.7 | 10 |
| K | | 2.8 | |
| Ca | | 1.8 | |
| Mg | | 2.2 | |
| Fe | | 0.207 | |
| Mn | | 0.035 | |
| B | | 0.007 | |
| Zn | | 0.56 | 1 |
| Cu | | 0.017 | |
| Mo | | 0000035 | |
| Co | | 0.00022 | |
| Se | | 0.00002 | |
| Si | | 0.00002 | |
| Ni | | 0.00022 | |
| Yield (kg/ha) | 8,981.5 | 12,030.8 | 10,365.8 |

The application of nitrogen-based, full-cycle Treatment 2 with a 220 liter per hectare dosage achieved the highest yield, 34% higher than control Treatment 1 and 16% higher than premium commercial Treatment 3. Treatment 2 had 66% less applied elemental nitrogen, 60% less applied elemental phosphorus, 93% less applied elemental sulfur and 44% less applied elemental zinc than Treatment 3. This demonstrates that the use of the applied elements in Treatment 2 was significantly more efficient than Treatment 3, due to the balanced nature of the nutritional composition of the nitrogen-based, full-cycle fertilizer. The nitrogen-based, full-cycle product with MFC obtains higher yields while also increasing nutrient efficiency and reducing the total amount of fertilizer applied, reducing possible losses of nutrients to the environment.

### Example 20

Example 20 illustrates preparation of an aqueous composition for the full cycle of a tomato crop. The following ingredients were mixed according to the same procedure as Example 8:

| Ingredient | Mass (g) |
|---|---|
| Water | 40 |
| MFC | 2.3 |
| Calcium nitrate | 22.7 |
| Potassium nitrate | 3.8 |
| Monopotassium phosphate | 5.4 |
| Magnesium sulfate | 12.1 |
| Potassium sulfate | 13.1 |
| Manganese sulfate | 0.06 |
| Zinc sulfate | 0.01 |
| Iron sulfate | 0.63 |
| Copper sulfate | 0.01 |
| Boric acid | 0.04 |
| Ammonium molybdate | 0.0013 |
| Cobalt sulfate | 0.00004 |
| Ammonium selenate | 0.00002 |
| Potassium silicate | 0.00004 |
| Nickel sulfate | 0.00003 |

A liquid suspension with a nutritional balance suitable for the full cycle of a generic tomato crop was obtained.

The suspension and composition of the present disclosure offer many advantages over conventional formulations. Among those advantages are the following.

The aqueous suspension with MFC allows for the combination of salts whose concentration would naturally lead to precipitates and reduced availability of individual nutrients in one concentrated product.

The elaboration of complete formulations that are totally balanced for each type of crop in only one suspension is possible, which results in higher yields because the crop suffers from no nutritional deficiencies in all its lifecycle.

Nutrients within the composition (either in its solid or liquid version) remain available for the plant regardless of the pH of the soil or substrate.

In the solid version of the composition, the nutrients are released on plant demand, enabling the application of an entire cycle's worth of nutrients in one single application.

Fertilizer use in simplified, because there is no longer a need to handle several solutions such as stock A and stock B, or various fertilizers each providing single elements.

Lower transportation costs and carbon footprint reduction are possible because it is possible to transport a greater quantity of salts in the same volume. Carbon footprint reduction is due to high nutrient use efficiency.

A reduction in packaging results because fewer wrappings are needed to deliver the complete formulations.

The adverse environmental impact is minimized due to reduced leaching, volatilization, explosivity or non-nutritional substances.

The product shelf-life increases due to the stability of the suspension.

Lower storage costs and convenient stock management are made possible.

The same suspension can be used in all agricultural applications: hydroponics, fertirrigation and direct soil fertilization.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure. It is expressly intended, for example, that all ranges broadly recited in this document include within their scope all narrower ranges which fall within the broader ranges.

What is claimed:

1. A concentrated aqueous composition for plant nutrition, comprising:
between 0.5% and 90% of water,
between 1% and 40% of a polymeric stabilizing agent having a high number of polar hydrophilic groups and the following % w/w nutrient elements:
0.1 to 30% nitrogen,
0.1 to 20% phosphorus,
0.1 to 20% potassium,
0.1 to 20% sulfur,
0.1 to 20% calcium,
0.1 to 20% magnesium,
0.001 to 2% zinc, and
0.001 to 0.2% boron,
wherein the concentration of calcium ions and sulfate ions exceeds the concentration corresponding to the normal solubility of calcium sulfate in water and wherein the availability of the nutrient elements is assured in a pH range of 1 to 13.

2. The concentrated aqueous composition for plant nutrition according to claim 1, further comprising the following % w/w of nutrient elements:
0.001 to 0.4% iron,
0.001 to 0.4% manganese,
0.001 to 0.05% copper,
0.0001 to 0.003% molybdenum,
0.000001 to 0.01% cobalt,
0.000001 to 0.001% selenium,
0.000001 to 0.1% silicon, and
0.000001 to 0.001% nickel.

3. The concentrated aqueous composition for plant nutrition according to claim 1, further comprising the following % w/w of nutrient elements:
1 to 20% nitrogen,
1 to 10% phosphorus,
1 to 9% potassium,
1 to 10% sulfur,
0.5 to 10% calcium,
0.8 to 8% magnesium,
0.01 to 0.2% iron,
0.01 to 0.2% manganese,
0.01 to 0.3% zinc,
0.005 to 0.04% copper,
0.0002 to 0.0005% molybdenum,
0.00001 to 0.00008% cobalt,
0.002 to 0.1% boron,
0.00001 to 0.0008% selenium,
0.00001 to 0.05% silicon, and
0.00001 to 0.0008% nickel.

4. The concentrated aqueous composition for plant nutrition according to claim 1, further comprising the following % w/w of nutrient elements:
3 to 11% nitrogen,
1.5 to 5% phosphorus,
3 to 7% potassium,
1.5 to 4% sulfur,
1 to 3% calcium,
1 to 2% magnesium,
0.04 to 0.08% iron,
0.02 to 0.05% manganese,
0.05 to 0.2% zinc,
0.01 to 0.02% copper,
0.0003 to 0.0004% molybdenum,
0.00003 to 0.00005% cobalt,
0.005 to 0.01% boron,
0.00003 to 0.0005% selenium,
0.00005 to 0.005% silicon, and
0.00003 to 0.0005% nickel.

5. The concentrated aqueous composition according to claim 1, wherein the nutrition elements are provided in the form of a salt, an acid or an oxide thereof.

6. The concentrated aqueous composition according to claim 5, wherein the salt, oxide or acid of the nutrient element is selected from the group consisting of ammonium nitrate, ammonium sulfate, calcium nitrate, calcium ammonium nitrate, calcium oxide, calcium chloride, potash, monopotassium phosphate, dipotassium phosphate, phosphoric acid, monoammonium phosphate, diammonium phosphate, potassium nitrate, potassium sulfate, potassium chloride, magnesium sulfate, magnesium nitrate, magnesium oxide, iron sulfate, iron nitrate, manganese sulfate, manganese nitrate, manganese chloride, sodium tetraborate, boric acid, zinc sulfate, zinc nitrate, zinc chloride, copper sulfate, copper nitrate, sodium molybdate, ammonium molybdate, cobalt sulfate, ammonium selenate, potassium silicate, sodium silicate, and nickel sulfate.

7. The concentrated aqueous composition according to claim 5, wherein the nutrition elements are provided in the form of an inorganic salt, oxide and acid thereof or a chelate thereof and the chelates of the nutrient elements are selected from Zn EDTA, Cu EDTA, Co EDTA, Fe EDTA, Mn EDTA, Mg EDTA, and Ni EDTA.

8. The concentrated aqueous composition for plant nutrition according to claim 1, wherein the polymeric stabilizing agent having a high number of polar hydrophilic groups is selected from the group consisting of microfibrillated cellulose, chemically modified microfibrillated cellulose, polysaccharides, and synthetic polymers.

9. The concentrated aqueous composition for plant nutrition according to claim 8, wherein the polymeric stabilizing agent having a high number of polar hydrophilic groups is microfibrillated cellulose chemically modified through oxidation, sulfonation, esterification, etherification, carbonylation, amidation or polymer grafting.

10. The concentrated aqueous composition for plant nutrition according to claim 8, wherein the polymeric stabilizer agent having a high number of polar hydrophilic groups is microfibrillated cellulose.

11. A concentrated aqueous composition for plant nutrition comprising (w/w):
between 0.5% and 90% of water;
between 1% and 40% of microfibrillated cellulose (MFC);
between 1% and 55% of calcium nitrate;
between 0.01% and 0.5% of magnesium EDTA;
between 0.01% and 0.7% of manganese EDTA;
between 0.01% and 0.7% of zinc EDTA;
between 0.01% and 0.9% iron EDTA;
between 0.01% and 0.1% of copper EDTA;
between 0.001% and 0.01% sodium molybdate (dihydrate);
between 0.0001% and 0.001% of cobalt EDTA;
between 0.01% and 0.4% of boric acid;
between 1% and 12% of potassium nitrate;
between 0.5% and 25% of monopotassium phosphate;
between 0.5% and 42% of magnesium sulfate; and
between 0.1% and 11% of potassium sulfate,
wherein the calcium ions and sulfate ions have a concentration in excess of the concentration corresponding to the solubility of calcium sulfate in water, and wherein the nutrient elements are available for plant nutrition in a pH range of 1 to 13.

12. The concentrated aqueous suspension for plant nutrition according to claim 11, further comprising:
18.6 liters of water (68.2% w/w);
6,000 grams of microfibrillated cellulose (22.0% w/w);
1,000 grams of calcium nitrate (3.7% w/w);
12 grams of magnesium EDTA (0.0440% w/w);
20 grams of manganese EDTA (0.0733% w/w);
20 grams of zinc EDTA (0.0733% w/w);
25 grams of iron EDTA (0.0916% w/w);
3 grams of copper EDTA (0.0110% w/w);
0.3 grams of sodium molybdate (dihydrate) (0.0011% w/w);
0.03 grams of cobalt EDTA (0.0001% w/w);
10 grams of boric acid (0.0366% w/w);
300 grams of potassium nitrate (1.10% w/w);
400 grams of monopotassium phosphate (1.47% w/w);
750 grams of magnesium sulfate (2.75% w/w); and
150 grams of potassium sulfate (0.55% w/w).

13. The concentrated aqueous suspension for plant nutrition according to claim 11, further comprising (w/w):
between 1% and 5% of potassium nitrate,
between 5 and 10% of monopotassium phosphate,
between 8% and 15% of magnesium sulfate, and
between 15% and 20% of calcium nitrate.

14. The concentrated aqueous suspension for plant nutrition according to claim 11, further comprising (w/w):
between 5% and 10% of potassium nitrate,
between 1% and 7% of monopotassium phosphate,
between 5% and 10% of magnesium sulfate,
between 5% and 15% of calcium nitrate, and
between 0.1% and 3% of potassium sulfate.

15. The concentrated aqueous suspension for plant nutrition according to claim 11, further comprising (w/w):
between 5% and 10% of potassium nitrate,
between 1% and 7% of monopotassium phosphate,
between 5% and 15% of magnesium sulfate, and
between 1% and 5% of calcium nitrate.

16. The concentrated aqueous suspension for plant nutrition according to claim 11, further comprising (w/w):
between 5% and 10% of monopotassium phosphate,
between 15% and 25% of magnesium sulfate, and
between 5% and 15% of calcium nitrate.

17. The concentrated aqueous suspension for plant nutrition according to claim 11, further comprising (w/w):
between 10% and 12% of potassium nitrate,
between 5% and 10% of monopotassium phosphate,
between 15% and 25% of magnesium sulfate,
between 25% and 35% of calcium nitrate, and
between 0.1% and 3% of potassium sulfate.

18. The concentrated aqueous suspension for plant nutrition according to claim 11, further comprising (w/w):
between 5% and 10% of potassium nitrate,
between 5% and 10% of monopotassium phosphate,
between 5% and 15% of magnesium sulfate, and
between 20% and 30% of calcium nitrate.

19. The concentrated aqueous suspension for plant nutrition according to claim 11, further comprising (w/w):
between 5% and 10% of potassium nitrate,
between 1% and 7% of monopotassium phosphate,
between 5% and 15% of magnesium sulfate, and
between 25% and 35% of calcium nitrate.

20. The concentrated aqueous suspension for plant nutrition according to claim 11, further comprising (w/w):
between 1% and 5% of potassium nitrate,
between 1% and 7% of monopotassium phosphate,
between 1% and 7% of magnesium sulfate, and
between 5% and 15% of calcium nitrate.

21. The concentrated aqueous suspension for plant nutrition according to claim 11, further comprising (w/w):
between 10% and 12% of potassium nitrate,
between 1% and 7% of monopotassium phosphate,
between 1% and 7% of magnesium sulfate, and
between 25% and 35% of calcium nitrate.

22. The concentrated aqueous suspension for plant nutrition according to claim 11, further comprising (w/w):
between 10% and 12% of potassium nitrate,
between 1% and 7% of monopotassium phosphate,
between 1% and 7% of magnesium sulfate, and
between 5% and 15% of calcium nitrate.

23. The concentrated aqueous suspension for plant nutrition according to claim 11, further comprising (w/w):
between 1% and 5% of potassium nitrate,
between 1% and 7% of monopotassium phosphate,
between 5% and 15% of magnesium sulfate, and
between 30% and 40% of calcium nitrate.

24. The concentrated aqueous suspension for plant nutrition according to claim 11, further comprising (w/w):
between 5% and 15% of calcium nitrate;
between 35% and 42% of magnesium sulfate;
between 10% and 12% of potassium nitrate; and
between 1% and 7% of monopotassium phosphate.

25. The concentrated aqueous suspension for plant nutrition according to claim 11, further comprising (w/w):
between 5% and 15% of magnesium sulfate,
between 10% and 20% of monopotassium phosphate,
between 5% and 15% of calcium nitrate, and
between 5% and 10% of potassium nitrate.

26. The concentrated aqueous suspension for plant nutrition according to claim 11, wherein the suspension comprises between 60% and 90% of water.

27. The concentrated aqueous suspension for plant nutrition according to claim 11, wherein the suspension comprises between 1% and 22% of MFC.

28. A concentrated aqueous composition for plant nutrition, comprising (w/w):
between 0.5% and 90% of water;
between 1% and 40% of microfibrillated cellulose (MFC);
between 1% and 55% of calcium nitrate or calcium ammonium nitrate;
between 1% and 16% of potassium nitrate;
between 0.5% and 25% of monopotassium phosphate or dipotassium phosphate;
between 0.5% and 42% of magnesium sulfate or magnesium nitrate;
between 0.1% and 15% of potassium sulfate;
between 0.1% and 30% ammonium nitrate;
between 0.05% and 21% monoammonium phosphate or diammonium phosphate;
between 0.1% and 16% ammonium sulfate;
between 0.01% and 0.7% of manganese sulfate;
between 0.01% and 4% of zinc sulfate;
between 0.01% and 0.9% iron sulfate;
between 0.01% and 0.1% of copper sulfate;
between 0.001% and 0.01% ammonium molybdate;
between 0.0001% and 0.05% of cobalt sulfate;
between 0.01% and 0.4% of boric acid;
between 0.0000001% and 0.01% of ammonium selenate;
between 0.0000001% and 1% of potassium silicate; and
between 0.0000001% and 0.01% nickel sulfate,
wherein the calcium ions and sulfate ions have a concentration in excess of the concentration corresponding to the solubility of calcium sulfate in water and wherein the nutrient elements are available for plant nutrition in a pH range of 1 to 13.

29. A solid or semisolid composition for plant nutrition, comprising:
between 0.01% and 20% of water;
between 1% and 60% of dry microfibrillated cellulose (MFC);
between 1% and 75% of calcium nitrate or calcium ammonium nitrate;
between 1% and 24% of potassium nitrate;
between 0.5% and 35% of monopotassium phosphate or dipotassium phosphate;
between 0.5% and 60% of magnesium sulfate or magnesium nitrate;
between 0.1% and 25% of potassium sulfate;
between 0.1% and 45% ammonium nitrate;
between 0.1% and 30% monoammonium phosphate or diammonium phosphate;
between 0.1% and 25% ammonium sulfate;
between 0.01% and 1.5% of manganese sulfate or manganese EDTA;
between 0.01% and 6% of zinc sulfate or zinc EDTA;
between 0.01% and 1.5% iron sulfate or iron EDTA;
between 0.01% and 1% of copper sulfate or copper EDTA;
between 0.001% and 0.1% ammonium molybdate or sodium molybdate;
between 0.0001% and 0.05% of cobalt sulfate or cobalt EDTA;
between 0.01% and 1% of boric acid;
between 0.0000001% and 0.01% of ammonium selenate;
between 0.0000001% and 1.5% of potassium silicate;
between 0.0000001% and 0.01% nickel sulfate; and
between 0.01% and 1% magnesium EDTA.

30. A solid or semisolid composition for plant nutrition comprising:
3% of water;
0.9% of dry microfibrillated cellulose (MFC);
45.9% of calcium nitrate or calcium ammonium nitrate;
16.6% of potassium nitrate;
10.3% of monopotassium phosphate;
20.9% of magnesium sulfate;
0.7% of potassium sulfate;
0.07% of manganese sulfate;
0.01% of zinc sulfate;
0.96% iron sulfate;
0.02% of copper sulfate;
0.004% ammonium molybdate;
0.0001% of cobalt sulfate;
0.13% of boric acid;
0.00005% of ammonium selenate;
0.00007% of potassium silicate; and
0.00005% nickel sulfate.

31. A substrate kit comprising:
an inert substrate suitable for crop growth;
a concentrated aqueous composition for plant nutrition or a solid or semi-solid composition for plant nutrition; and
a seed, bulb or seedling of a crop which requires the specific nutrients delivered in the concentrated aqueous suspension or solid or semi-solid composition for plant nutrition.

32. The substrate kit according to claim 31, wherein the concentrated aqueous composition for plant nutrition is according to claim 1.

33. The substrate kit according to claim 31, wherein the concentrated aqueous composition for plant nutrition is according to claim 11.

34. The substrate kit according to claim 31, wherein the concentrated aqueous composition for plant nutrition is according to claim 28.

35. The substrate kit according to claim 31, wherein the solid or semi-solid composition for plant nutrition is according to claim 29.

36. The substrate kit according to claim 31, wherein the solid or semi-solid composition for plant nutrition is according to claim 30.

37. The substrate kit according to claim 31, wherein the inert substrate is present in an amount of 90 to 99% w/w and the concentrated aqueous composition or the solid or semi-solid composition is present in an amount of 1 to 10% w/w.

38. A substrate kit for cultivating lettuce comprising:
a hydrated rockwool cube;
a solid fertilizer composition for lettuce; and
at least one 3-day lettuce seedling,
wherein the solid fertilizer composition for lettuce comprises the following ingredients:
3% of water,
0.9% of dry microfibrillated cellulose (MFC),
45.9% of calcium nitrate or calcium ammonium nitrate,
16.6% of potassium nitrate,
10.3% of monopotassium phosphate,
20.9% of magnesium sulfate,
0.7% of potassium sulfate,
0.07% of manganese sulfate,
0.01% of zinc sulfate,
0.96% iron sulfate,
0.02% of copper sulfate,
0.004% ammonium molybdate,
0.0001% of cobalt sulfate,
0.13% of boric acid,
0.00005% of ammonium selenate,
0.00007% of potassium silicate, and
0.00005% nickel sulfate.

39. A substrate kit for cultivating lettuce comprising:
a hydrated rockwool cube;
an aqueous fertilizer composition for lettuce; and
at least one) 3-day lettuce seedling,
wherein the aqueous fertilizer composition for cultivating lettuce comprises the following ingredients:
35% of water,
1.7% of microfibrillated cellulose (MFC),
30.4% of calcium nitrate or calcium ammonium nitrate,
11.0% of potassium nitrate,
6.8% of monopotassium phosphate,
13.9% of magnesium sulfate,
0.5% of potassium sulfate,
0.05% of manganese sulfate,
0.01% of zinc sulfate,
0.64% iron sulfate,
0.01% of copper sulfate,
0.003% ammonium molybdate,
0.0001% of cobalt sulfate,
0.09% of boric acid,
0.00003% of ammonium selenate,
0.00005% of potassium silicate, and
0.00003% nickel sulfate.

40. A substrate kit for cultivating tomato, comprising:
a hydrated inert substrate comprising 80% coco coir and 20% perlite;
a plurality of solid fertilizer tablets for full-cycle tomato; and
at least one 10-day tomato seedling,
wherein the solid fertilizer tablets comprise the following ingredients:
10% of water,
50.65% of microfibrillated cellulose (MFC),
14.65% of calcium nitrate,
4.39% of potassium nitrate,
5.86% of monopotassium phosphate,
10.99% of magnesium sulfate,
2.19% of potassium sulfate,
0.176% magnesium EDTA,
0.293% of manganese EDTA,
0.293% of zinc EDTA,
0.366% iron EDTA,
0.044% of copper EDTA,
0.044% sodium molybdate dihydrate,
0.0044% of cobalt EDTA, and
0.147% of boric acid.

41. A process for preparing a concentrated aqueous composition for plant nutrition comprising the step of mixing in water a salt, an oxide, an acid or a chelate of the following nutrient elements: calcium, magnesium, manganese, zinc, iron, copper, molybdenum, cobalt, boron, selenium, silicon, nickel, nitrogen, phosphorous, sulfur and potassium with microfibrillated cellulose (MFC) in order to obtain a complete concentrated aqueous composition for plant nutrition.

42. A process for preparing a concentrated aqueous composition for plant nutrition comprising the steps of:
a) preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel;
b) preparing a concentrated aqueous composition of stock B comprising a salt, an oxide or an acid of the following nutrient elements: nitrogen, phosphorous, sulfur and potassium;
c) mixing the concentrated aqueous composition of stock B with microfibrillated cellulose (MFC) to obtain a first concentrated aqueous composition; and
d) mixing the concentrated aqueous composition of stock A with the first concentrated aqueous composition obtained in step c) to obtain a complete concentrated aqueous composition for plant nutrition.

43. A process for preparing a complete concentrated aqueous composition for plant nutrition comprising the steps of:
a) preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel;
b) preparing a concentrated aqueous composition of stock B comprising a salt, an oxide or an acid of the following nutrient elements: nitrogen, phosphorous, sulfur and potassium;
c) mixing the concentrated aqueous composition of stock A with microfibrillated cellulose (MFC) to obtain a first concentrated aqueous composition; and
d) mixing the concentrated aqueous composition of stock B with the first concentrated aqueous composition obtained in step c) to obtain a complete concentrated aqueous composition for plant nutrition.

44. A process for preparing a solid or semisolid fertilizer composition for plant nutrition comprising the steps of:
a) mixing in water a salt, an oxide, an acid or a chelate of the following nutrient elements: calcium, magnesium, manganese, zinc, iron, copper, molybdenum, cobalt, boron, selenium, silicon, nickel, nitrogen, phosphorous, sulfur and potassium with microfibrillated cellulose (MFC) in order to obtain a concentrated aqueous composition;
b) pouring the concentrated aqueous composition obtained in step a) into a mold; and
c) dehydrating the concentrated aqueous composition of step b) at a temperature in a range of 50° C. to 130° C. for 12 to 72 hours up to a humidity content of 0.01 to 20%.

45. A process for preparing a solid or semisolid composition for plant nutrition comprising the steps of:
a) preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel;
b) preparing a concentrated aqueous composition of stock B comprising a salt, an oxide or an acid of the following nutrient elements: nitrogen, phosphorous, sulfur and potassium;
c) mixing the concentrated aqueous composition of stock B with microfibrillated cellulose (MFC) to obtain a first concentrated aqueous composition;
d) mixing the concentrated aqueous composition of stock A with the first concentrated aqueous composition obtained in step c) to obtain a second concentrated aqueous composition;
e) pouring the second concentrated aqueous composition of step d) into a mold; and
f) dehydrating the concentrated aqueous composition of step e) at a temperature in a range of 50° C. to 130° C. for 12 to 72 hours up to a humidity content of 0.01 to 20%.

46. A process for preparing a solid or semisolid composition for plant nutrition comprising the steps of:
a) preparing a concentrated aqueous composition of stock A comprising a salt, an oxide, an acid or a chelate of the following nutrient elements: calcium, magnesium, manganese, zinc, iron, copper, molybdenum, cobalt, boron, selenium, silicon, and nickel;
b) preparing a concentrated aqueous composition of stock B comprising a salt, an oxide or an acid of the following nutrient elements: nitrogen, phosphorous, sulfur and potassium;
c) mixing the concentrated aqueous composition of stock A with microfibrillated cellulose (MFC) to obtain a first concentrated aqueous composition;
d) mixing the concentrated aqueous composition of stock B with the first concentrated aqueous composition obtained in step c) to obtain a second concentrated aqueous composition;
e) pouring the second concentrated aqueous composition of step d) into a mold; and
f) dehydrating the concentrated aqueous composition of step e) at a temperature in a range of 50° C. to 130° C. for 12 to 72 hours up to a humidity content of 0.01 to 20%.

47. The process according to claim 44, wherein the compositions obtained in the last step containing between 10 and 20% humidity are semi-solid and the compositions obtained in the last step containing less than 10% humidity are solid.

48. The process according to claim 45, wherein the compositions obtained in the last step containing between 10 and 20% humidity are semi-solid and the compositions obtained in the last step containing less than 10% humidity are solid.

49. The process according to claim 46, wherein the compositions obtained in the last step containing between 10 and 20% humidity are semi-solid and the compositions obtained in the last step containing less than 10% humidity are solid.
